(19) United States
(12) Patent Application Publication
(10) Pub. No.: US 2019/0069375 A1
(43) Pub. Date: Feb. 28, 2019

(54) USE OF EMBEDDED DATA WITHIN MULTIMEDIA CONTENT TO CONTROL LIGHTING

(71) Applicant: ABL IP HOLDING LLC, Conyers, GA (US)

(72) Inventors: Youssef F. Baker, Arlington, VA (US); Daniel M. Megginson, Fairfax, VA (US); Sean P. White, Reston, VA (US)

(21) Appl. No.: 15/689,615

(22) Filed: Aug. 29, 2017

(51) Int. Cl. H05B 37/02; H04N 5/44; H04N 7/08

(52) U.S. Cl. CPC H05B 37/0227; H04N 7/08; H04N 5/44; H05B 37/0272

(57) ABSTRACT

Lighting system and method examples offer an immersive lighting environment. A multimedia interface of a receiver obtains multimedia content that includes video data, audio data and embedded lighting information. A receiver includes a processor to generate lighting commands for each of a number of luminaires based on the embedded lighting information from the multimedia content. A network interface of the receiver sends respective lighting commands to each of the luminaires, so that operations of controllable light sources of the luminaires are based on the received respective lighting commands (based on the embedded lighting information). This approach, for example, enables coordination of lighting in a venue with the output of the associated video and/or audio multimedia content. The lighting information may be scripted as part of multimedia content creation and/or created or adapted by crowd sourcing or machine learning of customer preferences.

### TECHNICAL FIELD

The present subject matter relates to techniques and equipment to read and interpret embedded lighting information from within multimedia content to control light sources, for example, for an immersive multimedia experience of the multimedia content.

### BACKGROUND

Electrically powered artificial lighting has become ubiquitous in modern society. Electrical lighting devices are commonly deployed, for example, in homes, buildings of commercial and other enterprise establishments, as well as in various outdoor settings. Typical luminaires generally have been single purpose devices, e.g. to just provide light output of a character (e.g. color, intensity, and/or distribution) to provide artificial general illumination of a particular area or space.

In recent years, presentation of audio visual materials has become increasingly sophisticated. The resolution of the video content and display has increased from old analog standards, to high definition and more recently to ultra-high definition. The accompanying audio presentation capabilities also have vastly improved. Surround sound systems, for example, often offer high-fidelity audio output via six channels with appropriate speakers distributed at appropriate locations about the venue where people may observe the content. Multimedia content for such systems may be obtained via a variety of media, such as traditional television networks (e.g. cable, fiber-to-the curb or home, satellite), portable media such as various qualities of optical disks, digital video recorder (DVR) files, and downloads or real-time streaming of programming via an Internet Protocol (IP) network (e.g. the Internet or an Intranet).

Originally lighting systems and multimedia presentation systems were developed and controlled somewhat separately, however, there have been recent proposals to coordinate lighting effects with the video and/or audio of a media presentation. Some approaches derive lighting control signals from analysis of the video and/or audio of the media presentation. Such an approach, for example, requires sophisticated analysis capability in or coupled to the receiver/presentation system at the venue to generate the lighting control signals, particularly if signal generation should be in real-time during the audio/video media presentation.

Another suggested approach uses lighting devices deployed in the vicinity of the multimedia video display (e.g. on a with or adjacent to the display, on the ceiling and/or on side walls of the room), where the lighting devices are essentially low resolution direct emitting display devices. Each such lighting device requires appropriate low resolution video signals to drive the emitters. The video signals for each such nearby lighting device may be extrapolated from the video data for the display device of the multimedia system, although the low resolution video signals for lighting may take the form of additional video data supplied to the multimedia system together with the higher definition video data. This later approach, however, requires complex and expensive lighting devices as well as rather complex data for use in driving the associated lighting devices at the venue.

Hence, there is room for further improvement.

### SUMMARY

The concepts disclosed herein alleviate problems and/or improve over prior lighting technology, for example, for association with a multimedia content presentation. The technology examples discussed in more detail below offer an immersive lighting experience, for example, coordinated with the output of the associated video and/or audio multimedia content.

An example immersive lighting system may include a data network, luminaires and a receiver. Each luminaire includes a controllable light source, a network interface to enable the respective luminaire to receive communications via the data network and a central processing unit. The light sources are positioned to output light in a space where a multimedia system displays video and outputs audio. In each luminaire, the central processing unit is coupled to the light source of the respective luminaire and to the network interface of the respective luminaire. The central processing unit is configured to control operation of the light source of the respective luminaire based on respective lighting commands received via the network interface of the respective luminaire. The receiver includes a multimedia interface, a network interface and a processor. The multimedia interface obtains multimedia content. That multimedia content includes video data and audio data intended to also be received by the multimedia system. The multimedia content further includes lighting information, embedded in the content with the video and audio data. The network interface enables the receiver to communicate with the luminaires over the data network. The processor is coupled to the network interface and to the multimedia interface. The processor is configured to generate the respective lighting commands for each respective one of the luminaires, based on the embedded lighting information from the multimedia content. The processor also causes the network interface of the receiver to send respective lighting commands via the data network to each respective one of the luminaires. Each respective luminaire is configured to receive the respective lighting commands via the respective data network and to control operation of the respective controllable light source of the respective luminaire based on the respective lighting commands received from the receiver.

Another example relates to a method. That example includes obtaining a stream of multimedia content containing video data, audio data and embedded lighting information. A display is provided and associated audio is output, via a multimedia system, responsive to the video data and the audio data of the multimedia content. The method example also includes extracting the lighting information from the stream of multimedia content. A processor generates respective lighting commands based on the extracted lighting information, for luminaires configured to controllably output light in a region where an occupant would observe the display and audio output from the multimedia system. Respective lighting commands are sent, via a network interface coupled to the processor, to each respective one of the luminaires. An operation of a controllable light source of each respective one of the luminaires is controlled based upon the respective sent lighting commands.

Another example relates to an article, which includes a machine readable medium and multimedia content on the medium. The multimedia content has a video data track of video content configured to enable real-time video display. The multimedia content also has audio data tracks of channels of audio content configured to enable real-time audio output synchronized with the real-time display of the video content. In this example, multimedia content also has lighting information data tracks of channels of lighting commands configured to control light generation by luminaires synchronized with the real-time display of the video content and the real-time audio content output.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

### BRIEF DESCRIPTION OF THE DRAWINGS

The drawing figures depict one or more implementations in accordance with the present concepts, by way of example only, not by way of limitations. In the figures, like reference numerals refer to the same or similar elements.

FIG. 1 is a functional block diagram of an immersive lighting system and of multimedia content distribution and presentation elements that may work together with the immersive lighting system.

FIG. 2 is a block diagram of some of the components of the systems/equipment of FIG. 1.

FIG. 3 is a simplified functional block diagram of an alternative example of a receiver with a lighting controller functionality, which may be used in the immersive lighting system of FIG. 1.

FIG. 4 is a simplified functional block diagram of an example of a media player, which may provide a stream of multimedia content to the receiver in the immersive lighting system of FIG. 1.

FIG. 5 is a flow chart of a simple example of a procedure for an artist, such as a producer or director, or a technician to create lighting related information that is then embedded as a track of multimedia content.

FIG. 6A is a simplified example of types of multimedia content and lighting control commands embedded as information within the multimedia content, and FIG. 6B shows an example of a channel assignment of identifiers to the lighting devices in a room setting as may be used in the lighting control command portion of the content of FIG. 6A.

FIG. 7A is a simple example of data links as may be implemented between an extractor/decoder and a data to lighting protocol converter functionality; whereas FIGS. 7B and 7C are simple examples of command structures of lighting information for transport as information embedded in multimedia content, which are suitable for the exchange of data represented by FIG. 7A.

FIGS. 8A to 8D are exemplary room lighting configurations using some of the elements of a system like that of FIG. 1.

FIG. 9 is a flow chart of a simple example of a procedure for providing an immersive lighting environment using a multimedia source having lighting related information embedded as part of the multimedia content, upon receiving multimedia content with an embedded lighting track.

FIG. 10 is a flow chart of a simple example of a procedure to procure lighting control information for a track of multimedia content.

FIGS. 11A and 11B together form a flowchart of an example of a lighting coordination algorithm for use in the procedure of FIG. 9.

FIG. 12 is a detailed example of a procedure to create a lighting track, based on a number of different inputs from various entities and a machine learning algorithm.

FIG. 13 is a simplified functional block diagram of a computer that may be configured as a host or server, for example, to host an on-line content or lighting track database.

FIG. 14 is a simplified functional block diagram of a personal computer or other work station or terminal device, for example, as may be used during a lighting track creation procedure.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The system and method examples discussed below and shown in the drawings offer an immersive lighting environment, for example, which coordinates lighting operations with the output of associated video and/or audio multimedia content via a multimedia presentation system operating in the same service area, e.g. in a media room or other venue.

An example lighting system includes a multimedia receiver with a multimedia interface to obtain content as well as a processor coupled to the multimedia interface and to a network interface. The multimedia content includes video data, audio data and embedded lighting information. The processor is configured to generate lighting commands for each of a number of luminaires based on the embedded lighting information from the multimedia content, obtained via the multimedia interface of the receiver. The network interface of the receiver sends respective lighting commands via a data network to each respective one of the luminaires, so that operations of controllable light sources of the various luminaires are based on the received respective lighting commands.

For example, this approach allows use of relatively simple lighting information and embedding thereof in lighting tracks, along with video and audio tracks, in the multimedia content. Lighting control may not require communication or derivation of video or video-like signals to drive the lighting devices. Also, this approach allows use of simpler lighting devices if desired by the venue operator, more analogous to controllable intelligent lighting devices intended for artificial general illumination applications at the venue. For example, the light sources of such devices may be point sources or multi-point sources configured in light panels or light bars but otherwise controllable via a lighting control protocol suitable for similarly structured controllable lighting devices, that is to say without the need for a special protocol to be developed for the immersive lighting application. The lighting information embedded in the content, however, may be protocol agnostic; in which case, the receiver converts the information to commands in any of a number of protocols that are suitable for the lighting devices at the location of and in communication with the particular receiver.

Another alternative or additional advantage is that the use of embedded lighting information reduces the amount of processing needed at the receiver, as compared for example, to systems that analyzed the video or audio content to determine how to control any associated lighting equipment.

The example technologies may be thought of as a tool utilized by both artists and consumers to expand the visual environment of media.

The lighting information may be scripted as part of multimedia content creation and/or created or adapted by crowd sourcing or machine learning of customer preferences. At the artist level, with the creation and embedding of a lighting information track into consumer level media (e.g., Blu-ray, other disk media, DVR files, or digital streaming or downloads over a network for movies or the like) the artist can craft and experience for the media consumer with another level of produced and intended immersion, similar to extending the audio experience to surround sound like that provided by Dolby 5.1 surround.

At the consumer level, the example technologies provide the ability to read and implement that embedded lighting information from the media that has been provided by the artist. That information will then be transferred to a lighting environment that may have been specified by the consumer for their specific needs and constraints, similar to a multimedia receiver/player, a display and speakers selected by the end user.

The resulting immersive environment gives the viewer a fuller experience than the audio/video presentation alone. The approach also may give artists/producers another medium to script the viewer's experience. The coordinated lighting effects may convey information in a visually “Haptic” way. The immersive environment, however, need not be virtual reality (VR), but the experience is more enveloping than the video would be if presented alone on the display.

The example technologies may also enable optimization of the environment at the consumer level, for example, using sensors and gauging equipment interfaced with the immersive lighting system. An example of this optimization might control glare or distortion seen in the environment during the multimedia presentation.

Some or all of these advantages and/or other advantages may become apparent from more detailed discussion of specific implementation examples in the description below and from the illustrations of such examples in the drawings.

The term “luminaire,” as used herein, is intended to encompass essentially any type of device that processes energy to generate or supply artificial light, for example, for general illumination of a space intended for use of occupancy or observation, typically by a living organism that can take advantage of or be affected in some desired manner by the light emitted from the device. However, a luminaire may provide light for use by automated equipment, such as sensors/monitors, robots, etc. that may occupy or observe the illuminated space, instead of or in addition to light provided for an organism. However, it is also possible that one or more luminaires in or on a particular premises have other lighting purposes, such as signage for an entrance or to indicate an exit. In most examples, the luminaire(s) illuminate a space or area of a premises to a level useful for a human in or passing through the space, e.g. general illumination of a room or corridor in a building or of an outdoor space such as a street, sidewalk, parking lot or performance venue. The actual source of illumination light in or supplying the light for a luminaire may be any type of artificial light emitting device, several examples of which are included in the discussions below. As discussed more below, a number of such luminaires, with communication and processing capabilities, are elements of an immersive lighting system and are controllable in response to suitable commands from a multimedia receiver such a system.

Terms such as “artificial lighting,” as used herein, are intended to encompass essentially any type of lighting that a device produces light by processing of electrical power to generate the light. An artificial lighting device, for example, may take the form of a lamp, light fixture, or other luminaire that incorporates a light source, where the light source by itself contains no intelligence or communication capability, such as one or more LEDs or the like, or a lamp (e.g. “regular light bulbs”) of any suitable type. The illumination light output of an artificial illumination type luminaire, for example, may have an intensity and/or other characteristic(s) that satisfy an industry acceptable performance standard for a general lighting application. In an immersive lighting application, the controllable parameters of the artificial lighting are controlled in coordination to a presentation of video and audio content.

The term “coupled” as used herein refers to any logical, optical, physical or electrical connection, link or the like by which signals or light produced or supplied by one system element are imparted to another coupled element. Unless described otherwise, coupled elements or devices are not necessarily directly connected to one another and may be separated by intermediate components, elements or communication media that may modify, manipulate or carry the light or signals.

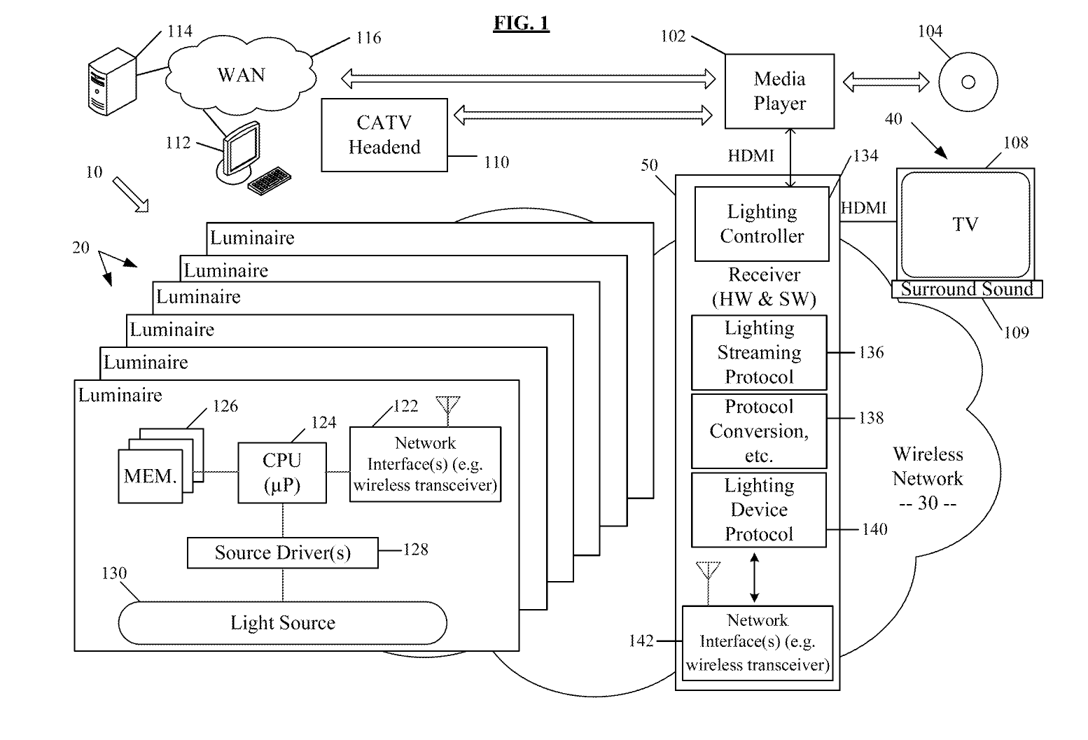

Reference now is made in detail to the examples illustrated in the accompanying drawings and discussed below. FIG. 1, in functional block diagram form, depicts an example of an immersive lighting system 10 and a number of other systems or devices that operate with the example immersive lighting system 10. The immersive lighting system 10 includes a number of lighting devices, in the form of luminaires 20.

The example immersive lighting system 10 also includes include a data network. Although other forms of network may be used, e.g. various types of wired or fiber networks, the example utilizes a wireless data network 30. The wireless network 30 may use any available standard technology, such as WiFi, Bluetooth, ZigBee, etc. Alternatively, the wireless network 30 may use a proprietary protocol and/or operate in an available unregulated frequency band, such as the protocol implemented in nLight® Air products, which transport lighting control messages on the 900 MHz band (an example of which is disclosed in U.S. patent application Ser. No. 15/214,962, filed Jul. 20, 2016, entitled “Protocol for Lighting Control Via A Wireless Network,” the entire contents of which are incorporated herein by reference). The system 10 may support a number of different lighting control protocols, for example, for installations in which consumer selected luminaires of different types are configured for a number different lighting control protocols.

Each of the luminaires 20 includes a controllable light source 130 and associated driver 128 to provide controlled power to the light source 130. the controllable light source 130 in each of the luminaires, in the example of FIG. 1, is a non-display type light source configured for controllable artificial general illumination. The source 130, however, may be of various types and may offer different degrees of controllable lighting output operations. The controllable light source 130 in each one the luminaires, for example, may be a point light source, a light bar type source formed by an arrangement of a number of individually controllable light emitters or a matrix source formed by individually controllable light emitters and/or any suitable combination of such arrangements of sources or emitters. The immersive lighting technologies described herein may be used with 2 consumer level, non-panelized light fixtures or even use existing home fixtures, assuming that the fixtures have sufficient communication and controllable capabilities.

By way of non-limiting example, the light source 130 may be a point source such a lamp or integrated fixture using one or more light emitting diodes (LEDs) as emitters, a fluorescent lamp, an incandescent lamp, a halide lamp, a halogen lamp, or other type of point light source. As another class of non-limiting examples, the light source 130 may use any combination of two or more such examples of point type sources as light emitters arranged in a light bar type source configuration. In the light bar examples, each emitter of a light bar type source may be individually controllable to provide different controllable light output along the bar. Similarly, a another class of non-limiting examples relates to matrix type the light sources. In this class, a light source 130 may use any combination of four or more such examples of point type sources as light emitters arranged in a matrix. In the matrix type source examples, each emitter arrange at a point of the matrix source may be individually controllable to provide different controllable light output at the various emitters locations across the matrix.

The type of light source driver 128 will correspond to the particular emitter(s) used to form the controllable light source 130. For example, if the source includes a number of similar LEDs of a particular color temperature of which light, the driver may be a single controllable LED driver configured to supply controllable driver current to the LEDs together as a group. In the simplest luminaire, the source or each point source of a bar or matrix may only be adjustable with respect to intensity. In other luminaire arrangements, the light source 130 and driver 128 may allow adjustment of overall intensity and overall color of the source output light (e.g. tunable white or a more varied color gamut) either for a single point configuration or for each point of a bar or matrix type source implementation.

By way of a more specific and highly variable example, if the controllable light source 130 includes a matrix of emitters where each emission point of the matrix has a number of LED emitters (on a single chip or in a number of collocated LED packages), for emitting different colors of light (e.g. red (R), green (G), blue (B) or RGB+white (W)), the source driver circuit 128 may be similar to a video driver but of a resolution corresponding to the number of emission points of the matrix. In such a matrix source example, adjustment of the outputs of the sources can provide tunable illumination at each matrix emission point as well as adjustment of the overall output of the source 130. While RGB or RGBW color lighting is described, emitters of the matrix may be capable of generating light, such as hyperspectral light that is composed of a number of different wavelengths of light that permits tuning of the matrix output to provide task lighting, if needed. Of course, other colored light systems such as cyan, magenta, yellow and black (CMYK) or hue saturation value (HSV) may be used.

The noted types of light sources and associated source driver technologies, however, are intended as examples of lighting equipment specifically designed for variable illumination light output, and need not be configured for real-time image display capabilities. For example, rather than an image or video display providing perceptible information output, a light bar or matrix type of the source 130 may be configured to output light of independently controllable intensity and/or color characteristics in different areas of the bar or matrix. The different output areas may be fixed or may vary in response to control signals applied to the different emitters forming the source 130, in such a bar or matrix example. The noted types of light sources and associated source driver technologies may be controlled in response to lighting commands, for example, specifying intensity and/or color for overall output or possibly for areas of matrix emitters as a group or possibly for individual points of a matrix. Examples of lighting command protocols for immersive lighting are discussed later in more detail.

The luminaires need not be video display devices. Also, the luminaires in different systems at different venues or even in one system 10 at a particular venue need not all be the same. Different entities designing and setting up a multimedia system 40 and associated immersive lighting system may choose different numbers and types of luminaires 20 for their different purposes, budgets etc.

The light sources are positioned to output light in a space where a multimedia system 40 displays video and outputs audio, for example, in a media-room or other venue intended for an immersive experience for people to consume the multimedia content. In a media-room type setting, the system 40 might include a high resolution video display device, generally represented by a television (TV) 108, as well as a hi-fidelity multi-channel sound system. The sound system often will use one or more speakers of the TV or a sound bar close to the TV and/or speakers of surround system, etc. For discussion purposes, the drawing shows an installation in which the sound system is a multi-channel surround sound system 109. The multimedia system 40 receives multimedia content that includes video and audio data, for example, received via High-Definition Multimedia Interface (HDMI) cable.

The TV (108), projection system or monitor used as the display and the sound system 109 forming the multimedia system 40 as well as the luminaires 20 are located in a venue in which one or more occupants may observe a multimedia presentation. Coordinated operation of the multimedia system 40 and luminaires 20 enables the lighting to support the content presentation in a more immersive manner, for example, to provide a more immersive experience for the occupant(s) than would be the case if the venue were merely dark or statically lit during the presentation. The coordinated lighting effects may convey intended feelings/experiences off screen, for example, by conveying information in a visually “Haptic” way from other locations about the venue, while allowing viewers in the venue to continue focusing on screen of the display 108.

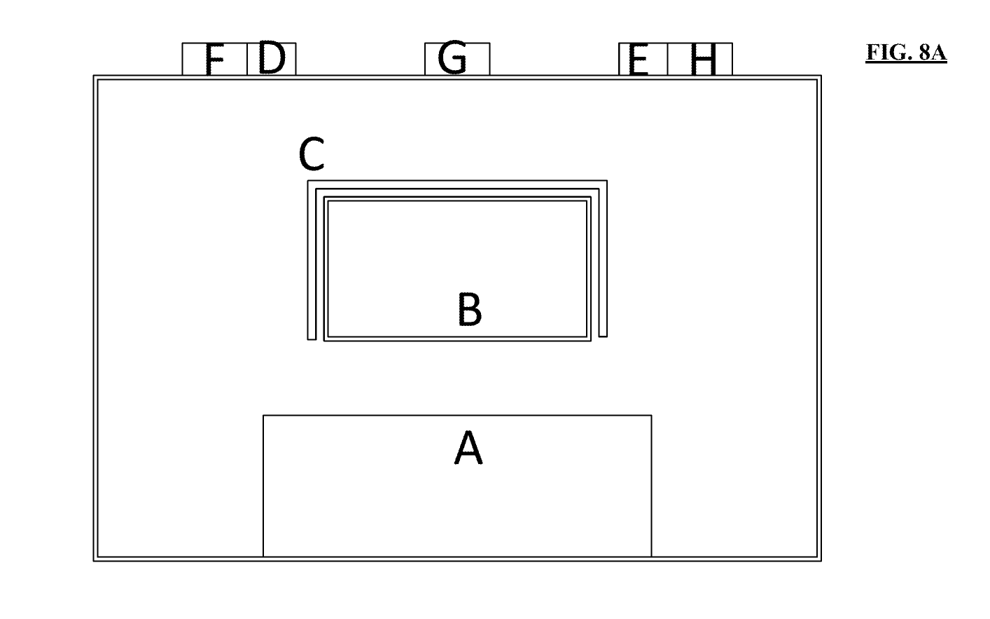

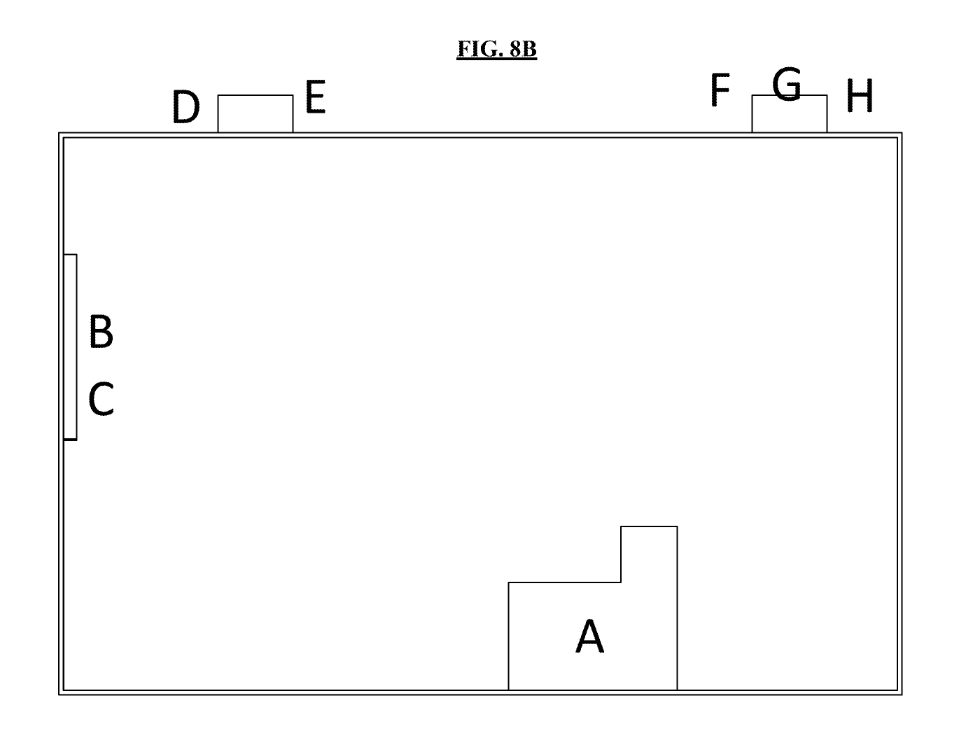

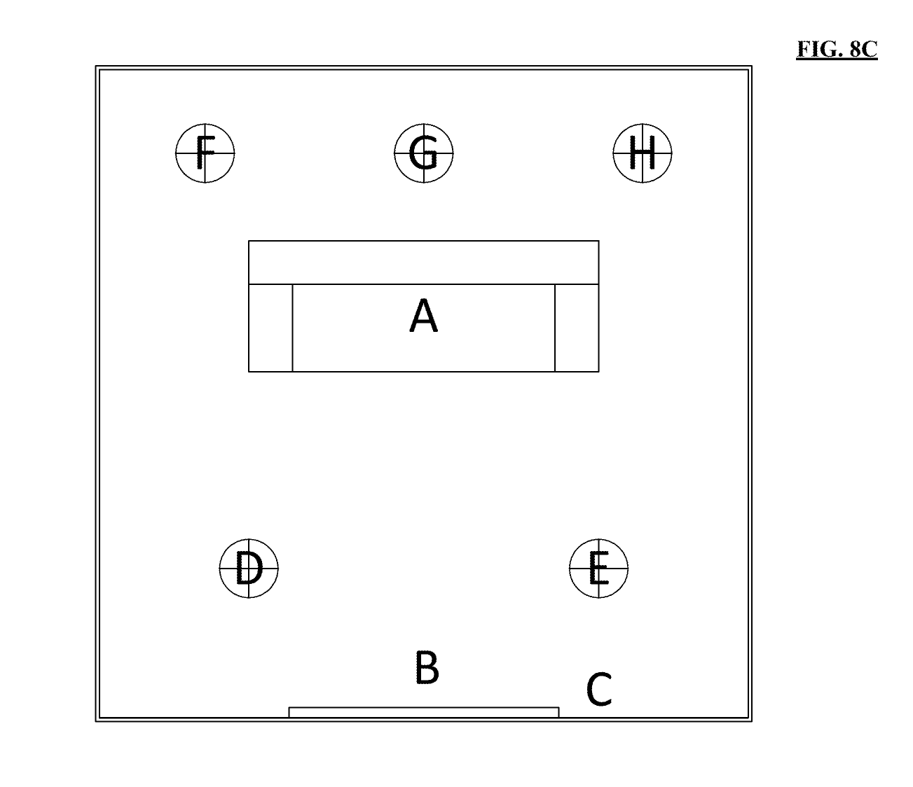

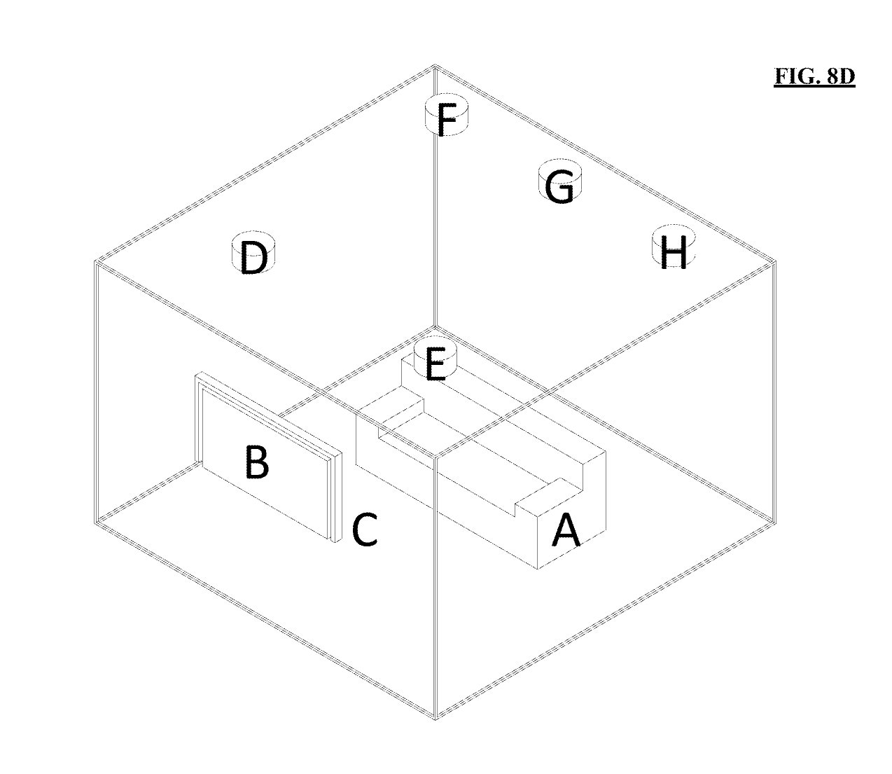

Several examples of possible media room type layouts, including locations of components of the multimedia system 40 and of luminaires 20, will be discussed later with reference to FIGS. 8A to 8D. The lighting system 10, however, may be used in other types of venues and/or with other implementations of a multimedia system.

Each of the luminaires 20 also includes a network interface to enable the respective luminaire 20 to receive communications via the data network. The circuitry and operational capabilities of the network interface would correspond to the media and protocols of the data network. For example, if the network is an Ethernet local area network using CAT-5 cabling, the network interface would be a suitable Ethernet card. Other wired interfaces or optical fiber interfaces may be used.

In the system example 10, where the data network is a wireless network 30, each luminaire 20 includes a wireless data transceiver 122 (e.g. including transmitter and receiver circuits not separately shown). Although the drawing shows only one transceiver 122, the luminaire 20 may include any number of wired or wireless transceivers, for example, to support additional communication protocols and/or provide communication over different communication media or channels for lighting operations or other functions (e.g. commissioning and maintenance).

Each of the luminaires 20 also includes a central processing unit (CPU) 124 which in this example is implemented by a microprocessor (μP). Each luminaire includes a memory 126 for storing instructions for the CPU 124 and data for processing by or having been processed by the CPU 124. Although disk or tape media could be used, typically today the memory 126 would be a suitable form of semiconductor memory, such as flash memory. Read only, random access, cache and the like may be included in the memories. In an example like that shown using a the memory 126 may be separate from the μP. Alternatively, the CPU 124 and the memory 126 may be elements integrated in a microcontroller unit (MCU). An MCU typically is a microchip device that incorporates such elements on a single chip. Although shown separately, the wireless transceiver 122 also may be integrated with the CPU 124 and memory 126 in an MCU implementation.

In each luminaire 20, the CPU 124 is coupled to the light source 130 via the driver 128 of the respective luminaire 20. The CPU 124 also is coupled to the network interface (wireless transceiver 122 in the example) of the respective luminaire 20. The CPU 124 is configured (e.g. by program instructions from memory 122) to control the driver 128 and thus operation of the light source 128 of the respective luminaire 20, based on respective lighting commands received via the wireless transceiver type network interface of the respective luminaire 20.

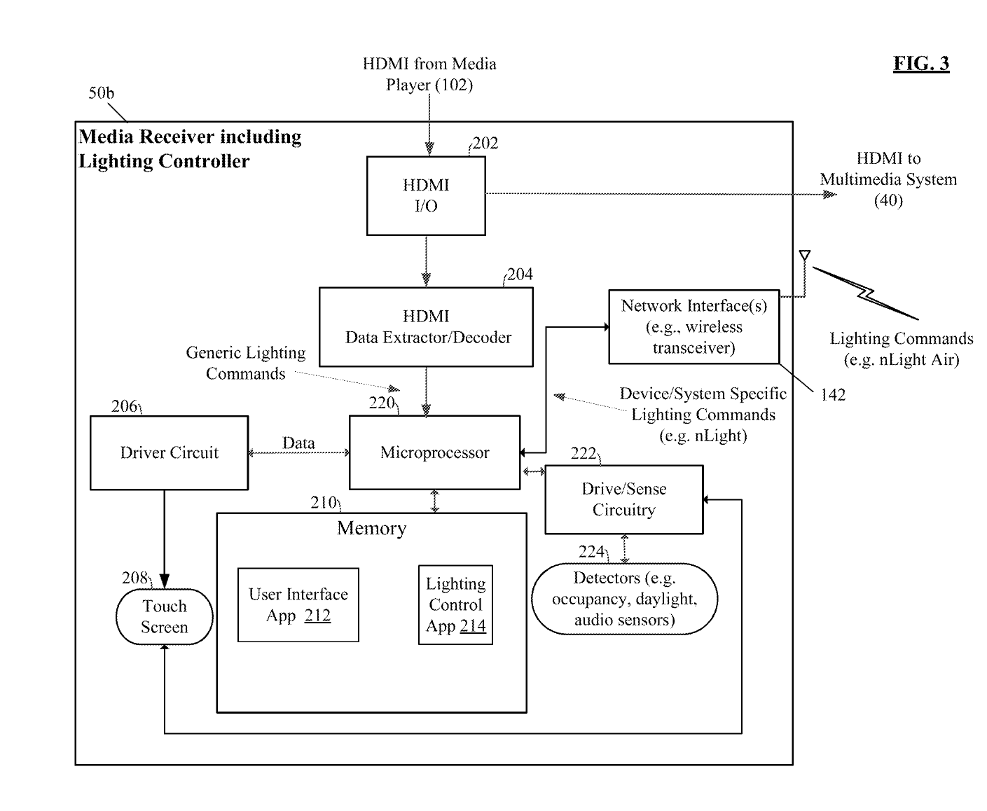

The example immersive lighting system 10 also includes a receiver 50. FIG. 1 shows a logical configuration of the receiver 50 that includes some hardware (H/W) and software (S/W) aspects of the receiver 50. For example, the receiver 50 includes/implements a lighting controller 134. As discussed more later, FIG. 3 is a functional block diagram of the hardware of the receiver 50 and lighting controller. With reference to FIG. 1, in addition to the lighting controller 134, the receiver 50 implements functions related to a lighting streaming protocol 136, and protocol conversion 138 and a lighting device protocol 140. At a high level, the lighting controller obtains multimedia content from a source and extracts lighting related information from the content. The lighting related information in the content is formatted in accordance with the lighting streaming protocol 136. The lighting related information in protocol 136 is converted at 138 to one or more lighting device protocols 140, suitable for providing corresponding lighting commands via a network interface 142 and the network 30 to the luminaires 20 of the particular system 10.

The receiver 50 obtains multimedia content from a content source, for example, via a media player 102. Although shown separately, for example, as if implemented by a personal computer, cable or satellite network type set-top box or a disk player; the media player may be incorporated in or otherwise combined with the receiver 50. The media player 102 may obtain particular multimedia content from one or more of a variety of suitable sources.

The drawing shows one such source as a video disk 104 of the like, in which case the media player might be implemented as a corresponding disk player unit or on a computer having a suitable disk drive. Examples of disk types of non-transitory computer readable medium include a compact disk read only memory (CD-ROM), a digital video disk (DVD), a digital video disk read only memory (DVD-ROM), a high definition DVD (e.g. Blu-ray disk), or an ultra-high definition DVD.

In a set-top box implementation of the media player 102, the player may communicate with the headend 110 of a cable television (CATV) network to obtain content as a real-time data streaming broadcast, a real-time data streaming on-demand transmission, a DVR file recorded from a broadcast or on-demand service, or a digital file download. Alternatively, if the media player 102 has data network access, e.g. through an Internet Service Provider (ISP), the media player 102 may communicate with a wide area network (WAN) 116, and through that network 112 with a terminal computer 112 or server computer 114 to obtain content in the form of real time data streams or file downloads. In these various examples, the media player 102 streams the obtained multimedia content, e.g. in real-time HDMI format, to the receiver 50.

In each of these source and media format examples, the multimedia content obtained from the multimedia source has lighting information encoded as commands or other types of data in lighting tracks embedded together with tracks of the video data and the audio data. In the disk or other non-transitory media examples, the encoded lighting information in lighting tracks is stored on the disk or other non-transitory media together with tracks of the video data and the audio data. Where the obtained multimedia content is streamed over or downloaded or recorded as a program content file through a CATV network or WAN, the data stream or program content file includes encoded lighting information as commands or other types of data in lighting tracks along with tracks of the video data and the audio data.

In these various examples, the media player 102 obtains the content that includes the lighting information in lighting tracks along with the video and audio tracks from the applicable multimedia source, and supplies the various lighting track, video track(s) and audio tracks in a data stream (e.g. as an HDMI output) to a multimedia interface of the receiver 50. The various tracks in the content obtained by the media player 102 and in the stream of content supplied from the player to the receiver 102 are predetermined in that tracks of video and audio are individually distinguishable from each other, and the lighting tracks are individually distinguishable from each other as well as distinguishable from the video and audio data tracks.

As discussed later in more detail, a processor of the receiver 50 is configured, e.g. by program instructions and/or protocol definitions to generate respective lighting commands for each of the luminaires 20 based on the embedded lighting information from one or more of the lighting tracks from of the data stream supplied from the media player. The network interface 142 in the receiver 50 communicates the lighting commands to the respective luminaires 20, and the CPUs 124 of the luminaires 20 control the respective light sources 130 (via drivers 128) based on received lighting commands, which in the example results in lighting outputs of the luminaires 20 controlled based on the embedded lighting information. This approach, for example, enables coordination of lighting in a venue with the audio visual outputs of the multimedia presentation system 40 (based on the video data and audio data with which the lighting information was embedded).

The processor of the receiver alone or in combination with network interface 142 may operate as a lighting controller relative to the luminaires 20. This lighting controller capability of the media receiver 50 may support more than one lighting control communication protocol, for example, adapted to support communications with different types of luminaires that communicate via different protocols. In a system 10 with luminaires 20 of one or more types that all utilize the same protocol, the lighting controller 134 selects and implements the one lighting control communication protocol (from among the supported protocols) for the communication of the lighting commands to the luminaires 20 of the immersive lighting system 10. In an installation, with two or more different types of luminaires using different communication protocols (e.g. from different lighting device manufacturers), the lighting controller 134 may select and use two or more appropriate protocols from among the available the lighting control communication protocols supported by the receiver/lighting controller, where the selected protocols are suitable for the communication of the lighting commands to the different types of luminaires 20 in the immersive lighting system 20.

Another example of immersive technology relates to an article, which includes a machine readable medium and multimedia content on the medium. Examples of the medium illustrated in FIG. 1 include disk 104 as well as the communication signals in the WAN 116 and the CATV network coupling the headend 110 to the player 102 as well as the physical network media of the WAN 116 and the CATV network. The disk 104 are examples of non-transitory types of storage media; and the wires or fibers of the networks are additional examples of transitory types of media that may bear the multimedia content. Although not shown, media such as memories and other storage devices in the server computer 114, the remote terminal device 112, CATV headend 110 are additional examples transitory types of storage media that may bear the multimedia content.

The multimedia content has a video data track of video content configured to enable real-time video display, that is to say output via the display 108 in the illustrated example. The multimedia content also has audio data tracks of channels of audio content configured to enable real-time audio output, e.g. via surround sound system 109, in a manner that is synchronized with the real-time display of the video content. In this example, multimedia content also has lighting information data tracks of channels of lighting commands configured to control light generation by the luminaires 20 in a manner that is synchronized with the real-time display of the video content and the real-time audio content output.

When not providing immersive lighting in coordination with the presentation of the multimedia content in the venue, the sources 130 of the system luminaires 20 may be operated to provide artificial light output for general illumination in the venue. Control of such general illumination functions may be provided by or through the lighting controller 134 capability of the receiver 50, although there may be one or more other lighting controllers (e.g. wall switches and/or sensors not shown) in the venue for general illumination control at such times. Further discussion of operations of the luminaires 20 and the receiver 50, however, will concentrate on immersive lighting functions coordinated with presentation of multimedia content by multimedia system 40.

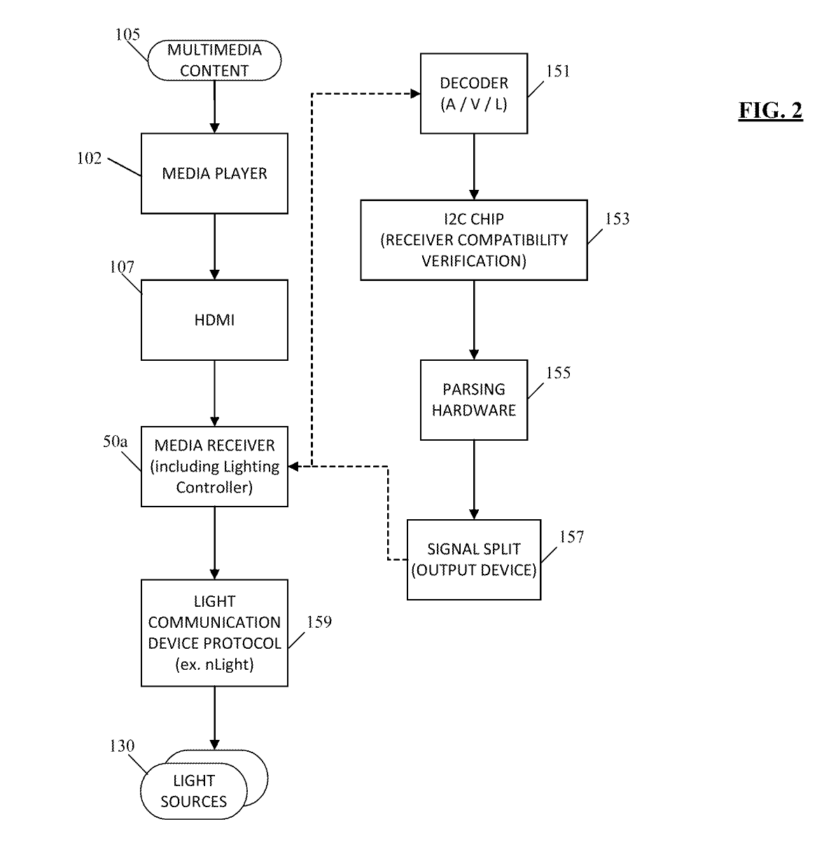

FIG. 2 is a block diagram of some of the components of the systems/equipment of FIG. 1; and elements that were shown in FIG. 1 are similarly labeled and numbered in FIG. 2. Hence, the media player 102 obtains multimedia content 105 from storage on by communication via one or more of the machine readable medium examples discussed above relative to FIG. 1. As outlined above, the obtained multimedia content 105 includes tracks of lighting information embedded with tracks of video and audio data. The media player 102 processes the obtained multimedia content 105 and supplies a HDMI formatted data stream 107, containing content, including tracks of lighting information embedded with tracks of video and audio data, to the media receiver 50a.

In this example, the media receiver 50a includes an audio (A), video (V) and lighting (L) decoder 151, for extracting and decoding the audio data, video data and lighting information from the respective tracks of the multimedia content 105 as supplied to the receiver 50. At a high level, the decoder 151 decodes the extracted audio and video data and the extracted lighting information into a format suitable for further processing. The decoder 151 may also decompress any compressed audio, video or lighting control information.

The media receiver 50a in the example of FIG. 2 includes an Inter-Integrated Circuit (I2C). An I2C chip 153, for example, may be a packet switched master/slave, serial bus type inter-processor coupling device, used for short distance communication between peripherals and/or processors, in this case for communication between the decoder 151 and other processing hardware of the media player 50a. In the example, a function of the I2C chip 153 is to perform a receiver compatibility verification.

The media receiver 50a in the example of FIG. 2 also includes parsing hardware 155 connected to I2C chip 153. The parsing hardware 155 is a circuit (logic circuitry or processor circuit) configured to parse the decoded data down to just the lighting information data (from the lighting tracks). The data from audio and video tracks is discarded. The media receiver 50a in the example of FIG. 2 also includes a signal splitting (output device) 157, which receives the lighting information data from the parsing hardware 155. The signal splitting device 157 is a logic circuit or programmed processor configured to separate lighting commands out of the lighting information into commands for individual ones of the luminaires 20 (see FIG. 1).

Although not separately shown in FIG. 2, the media player may include a processor. The media receiver 50a supplies the individual luminaire commands to a communication device 159 configured to convert the commands as may be necessary and send the commands via the applicable network to the luminaires for control of the sources 130. The device 159 may be a suitable transceiver coupled to or included in the media player 50a. Although other wireless and non-wireless communications may be used, a wireless example may send nLight® commands via wireless transceiver. The processor of the media receiver 50a and network interface functionality of the device 159 may operate together as a lighting controller relative to the luminaires 20 of the system 10 (see FIG. 1).

FIG. 3 depicts in some further detail an alternate example of a hardware implementation of the receiver 50b with the lighting controller functionality. The media receiver/lighting controller 50b may include a multimedia interface, for example, the HDMI input/output (I/O) interface 202. The multimedia interface 202 receives the multimedia content as a real-time stream (in HDMI format in the example) from the media player 102 (see FIG. 1).

The hardware of the receiver 50b also includes a network interface 142 and a processor (shown a as a microprocessor 220 in FIG. 2). Like the CPU 124, the processor of the receiver may be an MCU. Multi-core or multiprocessor implementations may also be used to implement the processor of the receiver 50b.

The network interface 142 is included within the receiver 20 in this example, although it may be provided as a separate unit coupled to the processor 220 of the receiver 50b. The network interface 142 is an interface compatible with the particular data network and the network interfaces of the luminaires 20 (see FIG. 1). In the specific examples of FIGS. 1 and 3, the network interface 142 may be a wireless transceiver similar to the transceivers of the luminaires 20 discussed earlier. Wired or fiber data communication interfaces may be used instead of or in addition to the wireless transceiver; and even in a wireless network implementation, there may be additional wireless transceivers in or coupled to the receiver.

In the example of FIG. 3, the processor (e.g. microprocessor 220) and the network interface 142 together operate as a lighting controller relative to the luminaires 20 of the system 10 (see FIG. 1).

The multimedia interface provided by the HDMI I/O 202 (FIG. 3) receives multimedia content from the media player 102, in the example, content which has been obtained by the media player 102 from any of the above discussed sources. The obtained content and thus the content that the player 202 supplies to the receiver 50b includes video data and audio data intended to also be received by the multimedia system 40 (e.g. for output via the TV 108 and the surround sound system 109). The multimedia content further includes lighting information embedded in the content with the video and audio data. In the example, the HDMI I/O 202 provides HDMI content to the multimedia system 40 (see also FIG. 1). The HDMI I/O 202 also provides HDMI content to a data extractor/decoder 204, in the example of FIG. 2.

In the example, the HDMI content provided to the data extractor/decoder 204 is essentially the full content as received from the media player 102, e.g. including the video and audio data as well as the embedded lighting information. The HDMI content provided to the multimedia system 40 includes the video and audio data for use by the system 40 and may include the lighting information although the system 40 typically does not need or use that information.

The microprocessor 220 is coupled to the multimedia interface (HDMI I/O) 202, in the example, via the data extractor/decoder 204. In this example, the element 204 is an HDMI extractor/decoder. At a high level, the HDMI data extractor/decoder 204 performs functions similar to the decoder 151 and parsing hardware 153 in the example 50a of the receiver shown in FIG. 2. The HDMI data extractor/decoder 204 extracts the lighting information from the multimedia content stream obtained via the HDMI I/O 202 and decodes the extracted information into a format suitable for processing by the microprocessor 220. Although the function of the extractor/decoder 204 may be implemented by software running on the microprocessor 220, in the example, the extractor/decoder 204 is a separate circuit implemented by appropriate data processing logic components or by programming a separate processor, such as an MCU or arithmetic processor or the like.

At this point, the lighting information may in essentially a generic lighting command format (not dependent on the protocol or protocols utilized by particular types of luminaires 20). The HDMI data extractor/decoder 204 is configured to extract and decode lighting control information in the obtained stream that conforms to the lighting streaming protocol 136 (see FIG. 1) used embedding of the information in the multimedia content.

The data extractor/decoder 204 may be implemented as a purpose built logic circuit, an application-specific integrated circuit (ASIC), a programmable gate array or the like; or the data extractor/decoder 204 may be implemented via programming of the microprocessor 220 or programming of another processor device coupled to the microprocessor 220.

The network interface 142 enables the receiver 50b to communicate with the luminaires 20 over the data network 30 (see FIG. 1). The microprocessor 220 is coupled to the network interface 142 and implements any protocol conversion (138 in FIG. 1) that may be needed between the generic lighting commands and the lighting device protocol(s) (140 in FIG. 1) used by the luminaires 20 of the particular lighting system 10 installation. The microprocessor 220 is configured to generate respective lighting commands for each respective one of the luminaires 20, based on the embedded lighting information obtained from the multimedia content. The commands are device and/or system specific, e.g. in the one or more protocols used by the luminaires 20 of the particular installation.

The processor also causes the network interface 142 of the receiver 50b to send respective lighting commands via the data network 30 to each respective one of the luminaires 20 (FIG. 1). Each respective luminaire 20 is configured to receive the respective lighting commands via the data network 30 and to control operation of the respective controllable light source 130 of the respective luminaire 20 based on the respective lighting commands received from the receiver 50.

The receiver and lighting controller 50b of FIG. 3 may have additional elements, several examples of which are shown in FIG. 2. In the microprocessor based implementation, the receiver 50b further includes one or more memories 210 coupled to the microprocessor 220. The memory stores instructions for the microprocessor 220 and data processed or to be processed by the microprocessor 220. Although disk or tape media could be used, typically today the memory 220 would be a suitable form of semiconductor memory, such as flash memory. Read only, random access, cache and the like may be included in the memories. In an MCU implementation of the receiver 50b, the processor circuitry forming the CPU and the memory would be included on one chip, possibly together with the applicable data communication interface (e.g. the wireless transceiver).

In the example of FIG. 3, the receiver 50b that offers the lighting controller functionality further includes a user interface capability. Although various types of user input devices (e.g. keypad, keyboard, cursor control devices, etc.) and user output devices (indicator lights, displays, speakers, etc.) may be used, the example includes a touch screen 208.

A touch screen 208 provides a combined display output to the user of the receiver/controller 50b as well as a tactile user input. The display may be a curved or flat panel display, such as a liquid crystal display (LCD) or an organic light emitting diode (OLED) display. For touch sensing, the user inputs would include a touch/position sensor, for example, in the form of transparent capacitive electrodes in or overlaid on an appropriate layer of the display panel. At a high level, such a touch screen 208 displays information to a user and can detect occurrence and location of a touch on the area of the display. The touch may be an actual touch of the display panel of screen 208 with a finger, stylus or other object; although at least some touch screens can also sense when the object is in close proximity to the screen. Use of a touch screen 208 as part of the user interface of the receiver/controller 50b enables a user of the receiver/controller 50b to interact directly with the information presented on the display panel.

A touch screen driver/controller circuit 206 is coupled between the microprocessor 220 and the touch screen 208. The touch screen driver/controller 206 may be implemented by input/output circuitry used for touch screen interfaces in other electronic devices, such as mobile devices like smart phones or tablet or ultrabook computers. The touch screen driver/controller circuit 206 includes display driver circuitry. The touch screen driver/controller 206 processes data received from the microprocessor 220 and produces drive signals suitable for the display panel of the particular type touch screen 208, to cause that display panel of the screen 208 to output visual information, such as images, animations and/or motion video. The touch screen driver/controller circuit 206 also includes the circuitry to drive the touch sensing elements of the touch screen 208 and processing the touch sensing signals from those elements of the touch screen 208. For example, the circuitry of touch screen driver/controller circuit 206 may apply appropriate voltage across capacitive sensing electrodes and process sensing signals from those electrodes to detect occurrence and position of each touch of the touch screen 208. The touch screen driver/controller circuit 206 provides touch occurrence and related position information to the microprocessor 220, and the microprocessor 220 can correlate that information to the information currently displayed via the display panel of the screen 208, to determine the nature of user input via the touchscreen. Similar detection over a period of time also allow detection of touch gestures for correlation with displayed information.

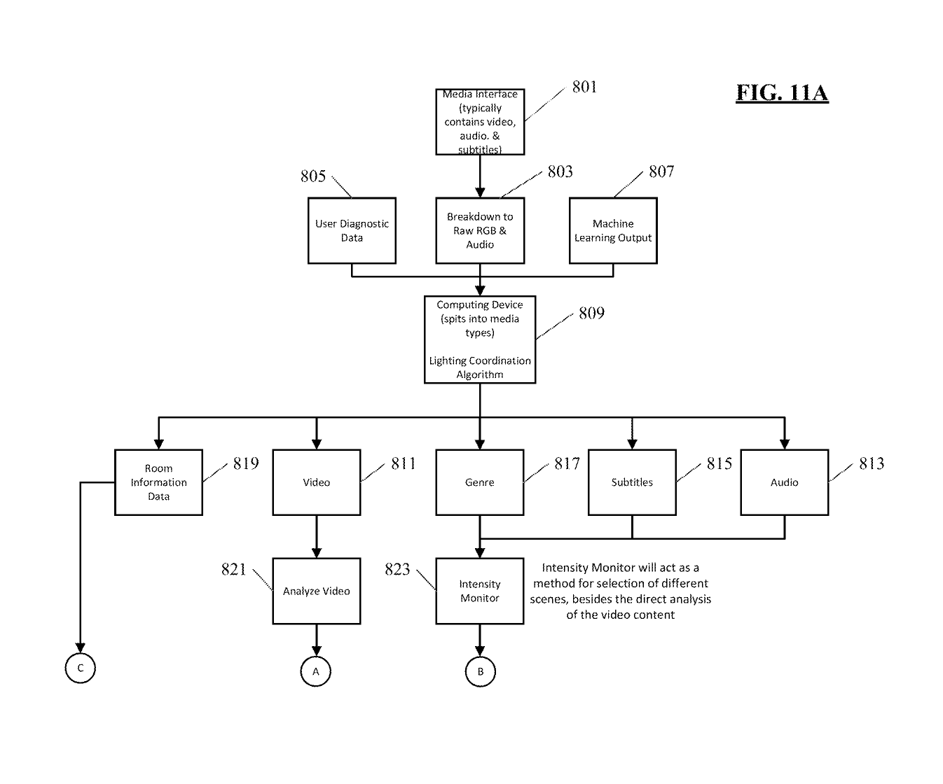

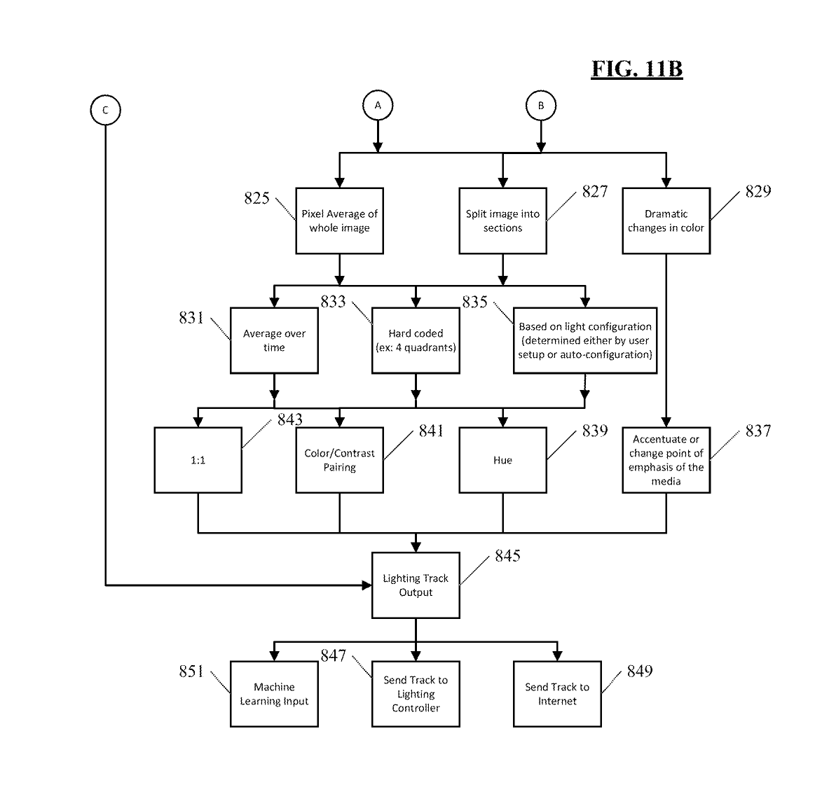

In this way, the touch screen 208 enables user inputs to the system 10 related to immersive lighting. Such inputs, for example, may allow a user to adjust aspects such as brightness and color contrast of the lighting device operations during immersive lighting while the multimedia system 40 is outputting the video and audio content of the multimedia presentation. Prompts or the like are provided via the display capability of the touch screen 208, user inputs are received as tactile inputs via the touch screen 208, and subsequent results/system responses are also visible on the touch screen display. The touch screen 208 also provides a user interface for input of preferences to a machine learning algorithm as discussed later in more detail with reference to FIG. 11 and/or for communication to a social media server or the like for example as part of a crowd-sourced adjustment of lighting control information to be associated with the video and audio content of the multimedia presentation in future distribution of the multimedia content.

As noted, when not providing immersive lighting during content presentation, the system 10 (FIG. 1) may provide general illumination in the venue; therefore the touch screen 208 enables user inputs to the system 10 related to controlling the light sources 130 (FIG. 1) for general illumination. Examples of inputs related to such general illumination may relate to turning light sources 130 (FIG. 1) ON/OFF, dimming and/or color characteristic control. The microprocessor 220 and transceiver 142 would respond to such inputs to format and send appropriate commands to the luminaires 20.

A system 10 like that of FIG. 1 may include sensing functionality. In the example of FIG. 3, the receiver 50b that offers the lighting controller functionality also implements a sensing functionality for the overall immersive lighting system 10. Hence, the example receiver/lighting controller 50b of FIG. 3 includes drive/sense circuitry 222, and one or more detector(s) 224. Each detector 224 detects a condition in the venue related to lighting in the venue and may be implemented by an available detector, such as a daylight detector, an occupancy detector, an audio detector, a temperature detector, or other environmental detector. The associated drive/sense circuitry 222 provides any signals, such as power and/or control signals, if necessary to operate the particular detector(s) 224. The drive/sense circuitry 222 also processes the signal(s) from the particular detector(s) 224 to produce data or the like indicating of the state or value of each detected condition. For example, the drive/sense circuitry 222 may detect a state change event via detector(s) 224 and signal the microprocessor 220 of the particular state change event (e.g. initial detection of presence or absence of an occupant). Alternatively or in addition, the drive/sense circuitry 222 may convert the signal from a detector 224 to a data value representing measurement of a detected condition (e.g. intensity of detected daylight or a detected temperature value) and forward the data value to the microprocessor 220.

Although shown in the receiver/lighting controller 50b, detector(s) 224 and associated drive/sense circuitry 222 for sensing one or more lighting related conditions in the venue may be provided in the system 10 in other system elements, instead of or in addition to the detector(s) 222 and circuitry 222 in the receiver/controller 50b. For example, similar detector(s) 224 and drive/sense circuitry 222 may be implemented in one or more of the luminaires 20 and events and/or data values communicated via the network 30 to other luminaires and/or to the receiver 50 (see FIG. 1) or 50b (FIG. 3). As another example, similar detector(s) 224 and drive/sense circuitry 222 may be combined with an MCU or the like and a corresponding network interface to implement a standalone sensor node on the network with the ability to communicate the results of the sensing through the network 30 to luminaires 20 and/or the receiver/controller 50 (see FIG. 1) or 50b (FIG. 3).

Such sensing may be used in a variety of ways to control the general illumination operations of the luminaires 20 of the system 10. The sensing, however, may also be used in association with immersive lighting operations of the system 10. For example, using daylight or ambient light sensing, the system 10 may adjust the intensity of the immersive lighting output of one or the sources 130 (or portion(s) thereof) from a desired or maximum intensity specified by the lighting information embedded in a lighting information track in the multimedia content. The condition sensing may also serve as an input to a machine learning algorithm to adjust parameters of the immersive lighting.

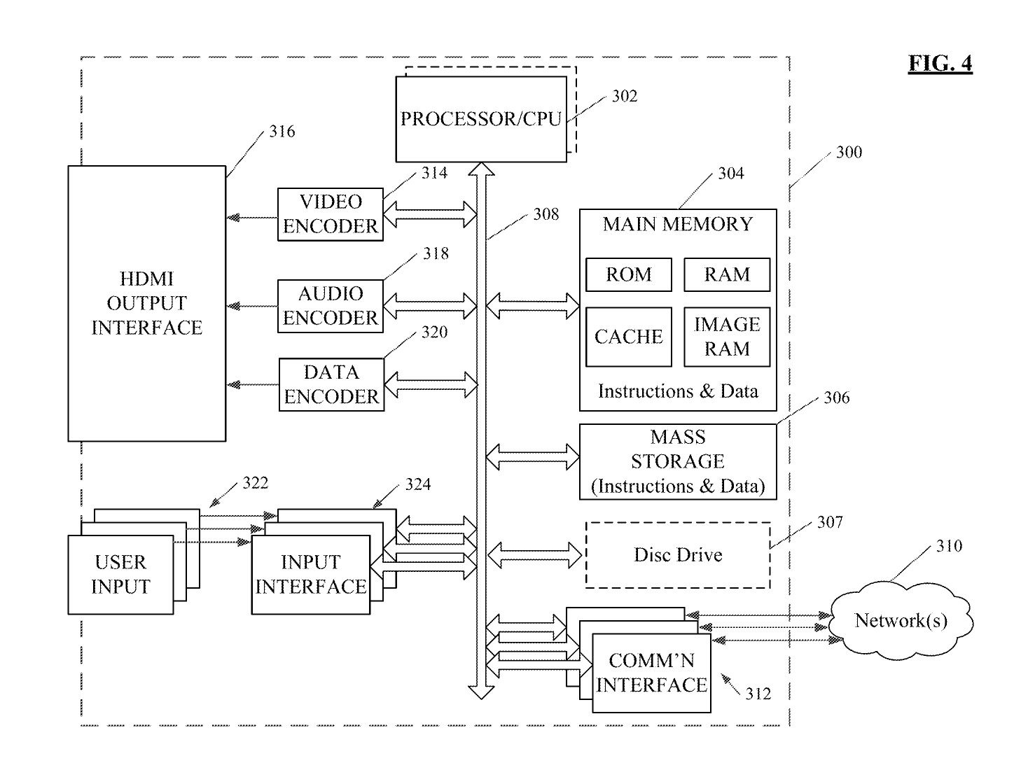

FIG. 4 depicts an example of a media player 300, which may serve as the media player 102 of FIG. 1. The block diagram implementation shown FIG. 4 is meant as a fairly generic representation of a class of player hardware with some user interface components and an HDMI output to the multimedia receiver/lighting controller 50. The player may be an off-the shelf device typically designed to provide content in HDMI format to a multimedia presentation system, e.g. for use in a venue that does not have immersive lighting system 10. In an implementation like, FIG. 1, the standard HDMI output is connected to supply multimedia content in real time to the HDMI input of the multimedia receiver/lighting controller 50. Such a media player device 102 or 300 may be a personal computer or the like (with audio video output devices not shown). By including somewhat different drives and/or network communication hardware, the illustrated hardware of player 102 or 300 may be configured to serve as a disk player or a set-top box for a satellite, fiber or cable type TV network.

With reference to FIG. 4, the example media player 300 includes processor circuitry forming a central processing unit (CPU) 302. The circuitry implementing the CPU 302 may be based on any processor or microprocessor architecture, such as a Reduced instruction set computing (RISC) using an ARM architecture, as commonly used today in mobile devices and other portable electronic devices, or a microprocessor architecture more commonly used in computers, such as an instruction set architecture (ISA) or Complex instruction set computing (CISC) architecture. The CPU 302 may use any other suitable architecture, including any suitable MCU architecture. Any CPU architecture may use one or more processing cores. The CPU 302 may contain a single processor/microprocessor, or it may contain a number of microprocessors for configuring the computer system 302 as a multi-processor system.

The media player 300 also includes a main memory 304 that stores at least portions of instructions for execution by and data for processing by the CPU 302. The main memory 304 may include one or more of several different types of storage devices, such as read only memory (ROM), random access memory (RAM), cache and possibly an image memory (e.g. to enhance image/video processing). Although not separately shown, the memory 304 may include or be formed of other types of known memory/storage devices, such as PROM (programmable read only memory), EPROM (erasable programmable read only memory), FLASH-EPROM, or the like. Although other storage technologies may be used, typically, the elements of the main memory 304 utilize semiconductor memory devices.

The media player 300 may also include one or more mass storage devices 306. Although a storage device 306 could be implemented using any of the known types of disk drive or even tape drive, the storage device 306 of the media player 300 typically utilizes semiconductor memory technologies. As noted, the main memory 304 stores at least portions of instructions for execution and data for processing by the CPU 302. The mass storage device 306 provides longer term non-volatile storage for larger volumes of program instructions and data. For example, the mass storage device 306 may store operating system and application software for uploading to main memory and execution or processing by the CPU 302. For a personal computer or a set-top box with digital video recorder (DVR) or other file storage capabilities, the mass storage device 306 also may store multimedia content data, e.g. obtained as a file download or stored from a movie or TV program type video stream from a broadcast service, on-demand service or on-line streaming service, for the multimedia presentations and immersive lighting discussed herein.

Alternatively or in addition to the mass storage device 306, a computer or disk player implementation of the player 300 may include a disk drive 307, for example, to enable the player 300 to obtain multimedia content from a disk type source medium. Such a disk drive 307, for example, may be configured to read one or more of a compact disk read only memory (CD-ROM), a digital video disk (DVD), a digital video disk read only memory (DVD-ROM), a high definition DVD, or an ultra-high definition DVD. Although not separately shown, the disk drive 307 may include or be coupled to the bus 308 via a suitable decoder circuit, to convert content from a format the drive reads from a particular type of disk to a standard internal format used within the player 300. Alternatively, any appropriate decoding may be implemented by programming run by the processor/CPU 302.

The processor/CPU 302 is coupled to have access to the various instructions and data contained in the main memory 304 and mass storage device 306 as to content from a disk in the driver 307 (if provided). Although other interconnection arrangements may be used, the example utilizes an interconnect bus 308. The interconnect bus 308 also provides internal communications with other elements of the media player 300.

The media player 300 may also include one or more input/output interfaces for communications, shown by way of example as several interfaces 312 for data communications via a network 310, which may be a CATV network or a WAN (see e.g. 116 in FIG. 1). Although narrowband modems are also available, increasingly each communication interface 312 provides a broadband data communication capability over wired, fiber or wireless link. Examples include wireless (e.g. WiFi) and cable connection Ethernet cards (wired or fiber optic), mobile broadband ‘aircards,’ and Bluetooth access devices. Infrared and visual light type wireless communications are also contemplated. Outside the media player 300, each such interface 312 provides communications over corresponding types of links to the network 310. In the example, within the media player 300, the interfaces communicate data to and from other elements of the system via the interconnect bus 308. Although not separately shown, the data communications interface(s) 312 may include or be coupled to the bus 308 to deliver obtained multimedia content via a suitable decoder circuit, to convert content from a format used by the particular network 310 to a standard internal format used within the player 300. Alternatively, any appropriate decoding may be implemented by programming run by the processor/CPU 302.

Optionally, the media player 300 further include one or more appropriate input/output devices and interface elements. The example offers input capabilities via user inputs 322 and associated input interface circuits 324. Although additional capabilities may be provided on the player itself, e.g. visual outputs and audible inputs and outputs on a laptop or tablet type implementation of the player, the example player 300 provides visual and audible outputs via the multimedia presentation system 40, which receive HDMI formatted content that is output by the player 300.

Examples of the user input devices 322 include one or more buttons, a keypad, a keyboard, any of various cursor control devices, a remote control device, etc. The interface circuits provide any signals needed to operate particular user input devices 322 and process signals from the particular user input devices 322 to provide data through the bus to the processor/CPU 302 indicating received user inputs.

As noted above, for visual and audio output, the media player 300 supplies an HDMI format multimedia content stream to the receiver 50 and the multimedia presentation system 40. Hence, the example media player platform 300 includes an HDMI output interface 316. In the example, multimedia content handled by the player 302 may not be in a format for direct use by the HDMI output interface 316, either as obtained from a disk drive 307 or a communication interface 312 or as stored/communicated within the player 300 on the bus 308 and/or to and from the processor/CPU 302. For such situations, the player 300 uses encoders 314, 318 and 320 to encode video data, audio data and other date to format(s) suitable for HDMI output via the interface 316. The data may include typical non-video, non-audio information such as text. Of note for this discussion, the data encoder 320 also may encode lighting control information data.

A mobile device type user terminal also may be used as the media player, in which case the mobile device/player would include elements similar to those of a laptop or desktop computer, but will typically use smaller components that also require less power, to facilitate implementation in a portable form factor. Some portable devices include similar but smaller input and output elements. Tablets and smartphones, for example, utilize touch sensitive display screens, instead of separate keyboard and cursor control elements. Rather that an HDMI cable connection, a mobile device may stream content over a wireless link to a device that receives the content and converts to an HDMI format for cable delivery to the receiver 50.

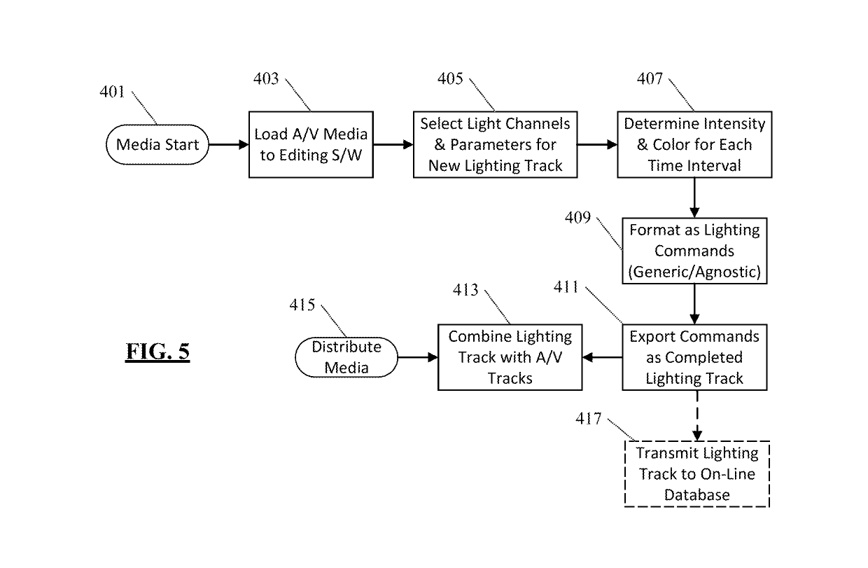

The lighting information may be scripted as part of multimedia content creation, for example, much like scripting audio or video or the like as part of a movie, program or game or the like during production processing. FIG. 5 is a flow chart of a simple example of a procedure for an artist, such as a producer or director or a production technician or the like, to create lighting related information that is then embedded as a track of multimedia content.

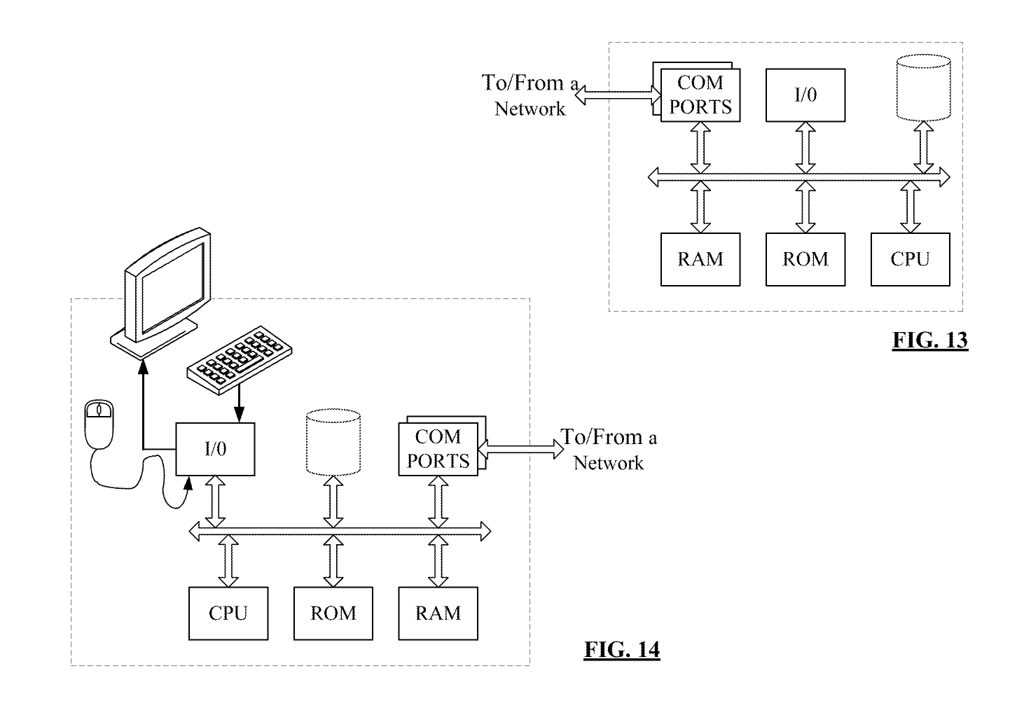

The example process begins (at step 401) with start of playback/processing of the existing media content for the particular production, which at this point is the multimedia content prepared by one or more artists or technicians working on a project (e.g. a movie, television program, video game, etc.). For discussion, we will generally assume that the media content started at 401 is a new product, but the process may be applied to older pre-existing content. The content started at 401 includes the audio (A) and video (V) content and any other associated content (e.g. text for subtitles or the like) generated by other typical production procedures. In step 403, at least the audio (A) and video (V) content is loaded into media editing software (S/W) running on a computer (examples of which appear in FIGS. 13 and 14) or on a system of such computers. Examples of editing software include Sony Acid and Adobe Premiere, although other programs supporting a capability to create additional multimedia tracks may be used as the editing software.

The computer or system offers a user interface, including audio visual outputs and appropriate user input features, to allow a person (e.g. artist or technician) to observe the audio and video content and provide inputs to modify the audio or video content or in this case to add content for an additional track. The track to be created via the editing software and the user interface capability of the computer or system of computers is a lighting track. The editing software and the user interface via the computer or system of computers essentially allow the person creating the track to script lighting operations of luminaires that will be controlled by commands of defined information in several channels of the new track, much like scripting and generating audio, video and/or associated text for a new multimedia presentation.

In step 405, the person inputs definitional information about the new lighting track, in the example, the number of lighting control channels to be included in the track and embedded together with the audio and video content tracks as well as parameters for the information to be formatted as generic (lighting device agnostic) commands in each lighting control channel contained in the new track. For example, the person may select 6 to 10 or more lighting channels. The person may also specify, for each channel, the command format. As selected generic/agnostic command format, for example, may contain RGB or RGBW data and/or cool to warm white color characteristic data, and/or an overall intensity data. The command format for all or a selected number of channels may be the same, or the command format may differ between some or all of the selected number of channels.

Having selected the number of channels and the format of command information to be carried in the channels of the lighting track, the person creating the track in step 407 determines and inputs the appropriate lighting control parameters (e.g. actual settings for RGB or RGBW, white color characteristic data, and/or an overall intensity data per the selections in step 405). The light setting data inputs in step 407 include inputs for commands to be carried in each channel for each time interval of the multimedia presentation. The person, for example, may observe playback of the audio and video content and/or a computer analysis of that content, make decisions for scenes or segments of the content, determine appropriate timing relative to the audio and video content, and input the desired lighting parameters so as to achieve coordinated lighting in support of the audio visual aspects of the multimedia production.

In step 409, the editing software processes the lighting control parameters such as intensity and color as well as timing related data regarding synchronization with selected time intervals of the audio or video content from step 407 to format the parameters and timing data into lighting commands for the number and type of channels specified in step 405. The lighting information embedded as commands in the lighting track channels may be protocol and/or lighting device agnostic, e.g. generic with respect to various types of lighting devices that may ultimately be controlled based on the lighting information and/or with respect to various types of lighting control protocols suitable to command controlled operations of actual lighting devices in various venues/user systems.

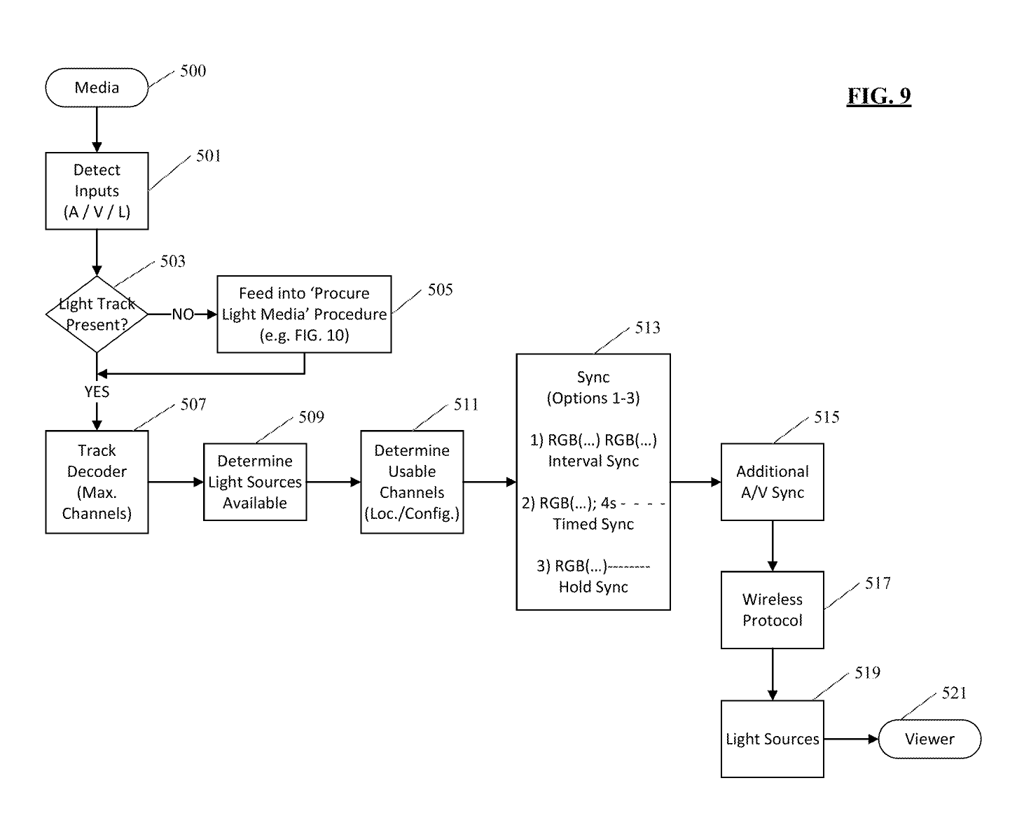

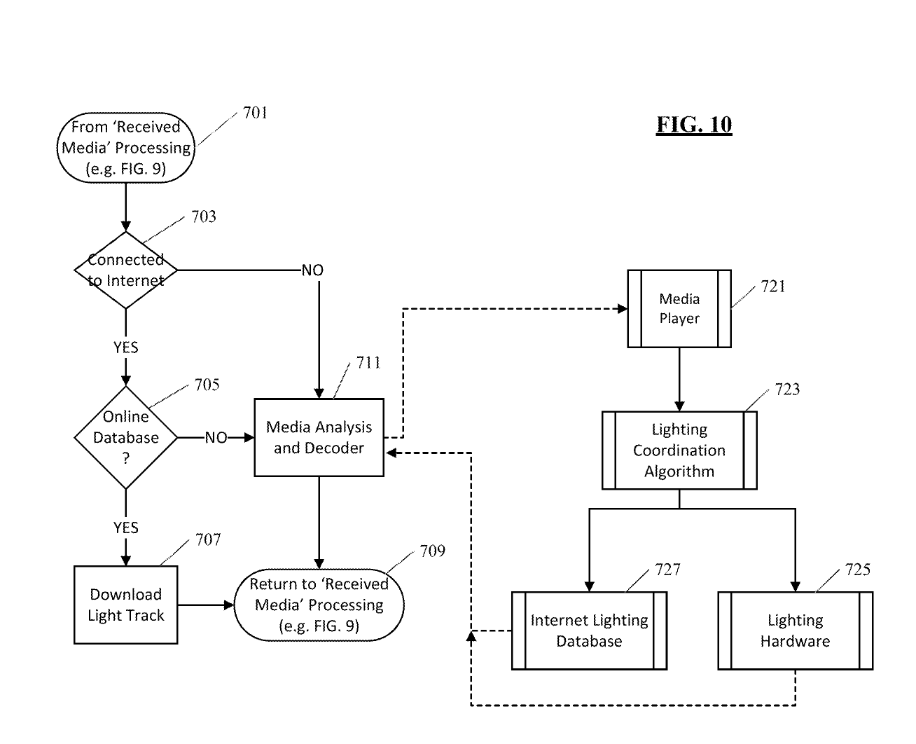

The lighting commands produced in the process of FIG. 5 will include timing information in support of synchronizing controlled lighting operations to playback of the other components of a multimedia presentation. Examples of techniques to establish timing for synchronization with the video and/or audio content which may be included as part of steps 407 or 409 are discussed in more detail with regard to part of a later example (see e.g. discussion of 513 in FIG. 9). The information to facilitate such synchronization would be created in response to selections entered at step 407 and appropriately formatted as commands in step 409 in the process of FIG. 5.

In step 411, the formatted lighting commands are exported in the form of a completed lighting track. In step 413, the editing software combines the lighting track with the audio and/or video tracks (and possibly any other tracks) of the multimedia production (from steps 401, 403).

Although shown as a single linear sequence of steps, actual production may involve any number of iterations of relevant steps in the illustrated order or a different order, to create a lighting track for an entire multimedia production. For example, individual scenes or segments may be processed separately as shown to create sections of the lighting track and then combined at the end of production to form one longer track for the entire length of the particular multimedia production. Also, after initial creation of a lighting track, the audio, video and lighting track may be run through the system again to allow the artist or technician to further edit the lighting track as desired. Although not shown in FIG. 5, adjustments of the lighting track may be based on other inputs, such as feedback from users and machine learning or crowd sourced editing suggestions from a suitable group.

When production is complete after step 413, the resulting combined multimedia content, for example, may be stored and/or distributed to any number of systems 20 via the technologies outlined above for supplying content to media player 102 of FIG. 1.

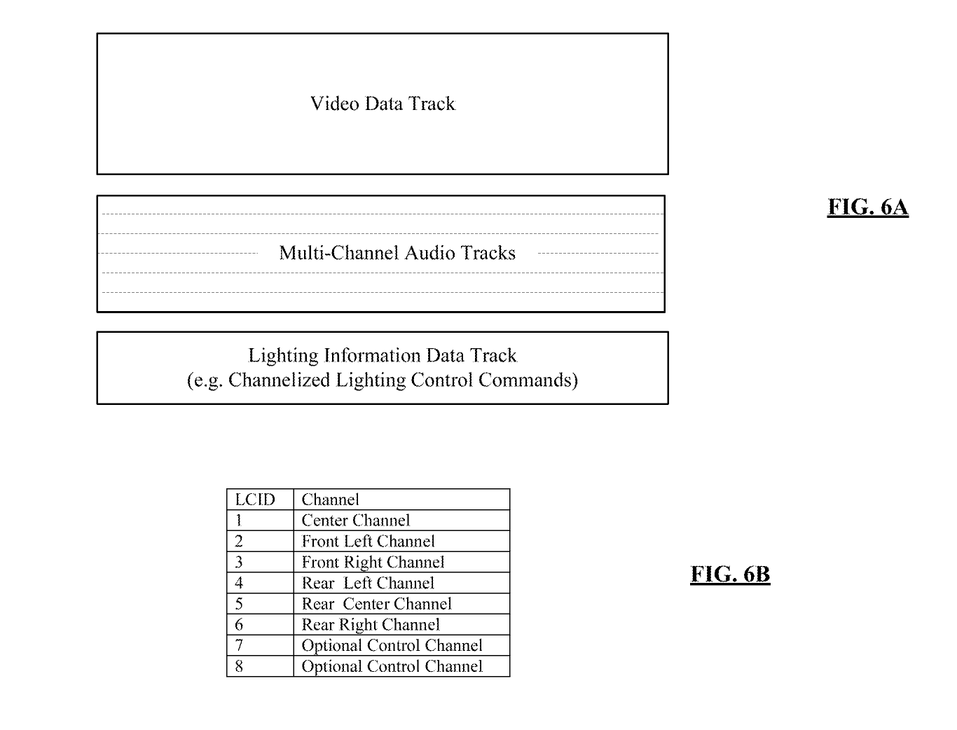

Optionally, the lighting track 411 may be provided to an on-line database as shown at 417. The database, for example, may enable various types of end user access to and even end user feedback on or modification of the lighting track associated with a particular multimedia production. Several processing examples, which may utilize tracks from such a database, are described later. FIG. 6A is a simplified example of types of multimedia content and lighting control commands embedded as information within the multimedia content, and FIG. 6B shows an example of a channel assignment of identifiers to the lighting devices in a room setting as may be used in the lighting control command portion of the content of FIG. 6A. These illustrations represent high-level logical examples of tracks of the multimedia content as may be obtained from a source by the media player and/or as may be received by the receiver/lighting controller from the media player.

At a high level (FIG. 6A), the overall multimedia content includes a video data track and some number of audio data tracks for a multi-channel audio output (e.g. six tracks/channels of surround sound audio output). In addition, the overall multimedia content includes at least one lighting information data track to carry channelized lighting commands. Compared to the video data and multi-channel audio data, intended for real-time presentation to a viewer via a multimedia system 40 (FIG. 1), the lighting commands intended for luminaires may include relatively small amounts of data for each control channel and be carried in a single track of the combined multimedia content as shown in the example of FIG. 6A.

Within a particular lighting information data track, the commands may be channelized in various ways, for example, by use of a lighting control channel identifier (LCID) in each command in the particular lighting information data track. FIG. 6B shows the LCIDs and respective channels within the track, for an arrangement that supports up to eight different channels. The LCID values are numerical for convenience, but other identifier formats may be used. The LCID 1 indicates that a command with that identifier is intended for luminaire(s) of a center lighting control channel, LCID 2 identifies a front left lighting control channel, etc.

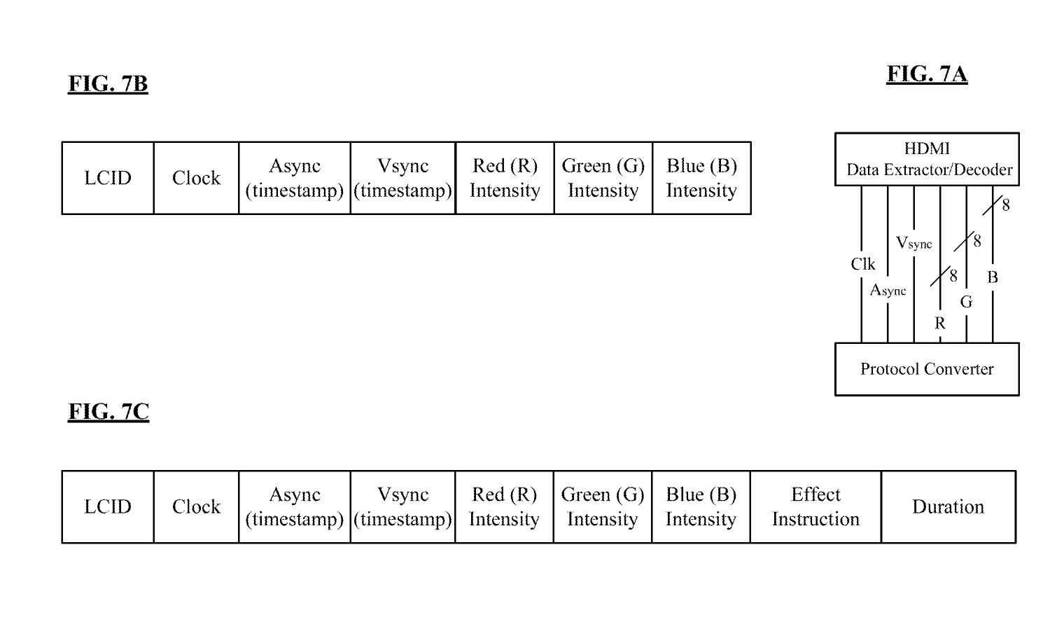

FIGS. 7A to 7C may be helpful in understanding some examples of implementations of the commands that may be carried in a channelized lighting information data track, as described above with respect to FIGS. 6A and 6B.

FIG. 7A is a simple example of data links as may be implemented between an extractor/decoder (see e.g. 204 in FIG. 3) and a data to lighting protocol converter functionality (see 138 in FIG. 1) as might be implemented by appropriate programming as a processor of the media player 50a (FIG. 2) or the media player 50b (FIG. 3). In the example of FIG. 7A, the links include a clock (Clk), an audio synchronization signal (Async) and a video synchronization signal (Vsync). The clock may be a time value for an overall system clock. The audio and video synchronization signals may be timestamps corresponding to those used at points in the audio and video data tracks to synchronize audio and video content playback. The clock and timestamps may be used for triggering the settings carried in a lighting control command in unison with the points in the video and audio outputs.

The simple example assumes information to control three colors of light output Red (R), Green (G) and Blue (B). Overall color characteristics of light output such a color corrected temperature (CCT) and overall intensity are controlled by specified relative RGB intensities. In the example, each of the R data, the G data and the B data takes the form of 8 bits of respective data for each command. Additional control data links or channels may be provided, for example, for additional controllable colors. An alternative approach might use two links/channels (instead of RGB). The two alternative links or channels may have the same or more bits; the first such link or channel might specify an overall intensity value whereas the second such link or channel might specify a characteristic color value, such as chromaticity.

FIG. 7B shows a first simple example of a command structure of lighting information for transport as information embedded in multimedia content, which is suitable for the exchange of data represented by FIG. 7A (including RGB data). As shown, the command includes a field for the LCD for the particular lighting control channel within the lighting information data track. The command also includes a field for the system clock as well as timestamp fields for audio synchronization (Async) and video synchronization (Vsync). The command shown in FIG. 7A then includes three eight bit fields for Red (R) intensity, Green (G) intensity and Blue (B) intensity. The command structure of FIG. 7B may be suitable for conversion to and sending of RGB( . . . ) commands that the receiving luminaire(s) implement and hold, either for a pre-set interval or until a subsequent command for the control channel is received by the receiving luminaire(s) on the particular channel.

The example command structure of FIG. 7C includes fields like those of FIG. 7B, but the example of FIG. 7C includes two additional fields. The first additional field is for some number of bits for an effect instruction, such as for a defined transition from a prior state to the specified state, from the specified state to an OFF state or other subsequent state, or for some effect while the state specified in the command is maintained (e.g. ON/OFF flashing or a an overall intensity modulation). The other additional field contains data specifying a duration. Depending on the implementation of the protocol, the specified duration may be the time that the settings in the command should be maintained or the duration of the effect.

The command formats shown in FIGS. 7B and 7C are examples only. It will be understood that the multimedia content may include the lighting information in other formats in the lighting track(s). Also, the examples mainly show the types of data that may be included in the commands for lighting-related purposes. Actual commands may include additional fields, for example, start and/or end indicators, data for error detection or correction, command type indicators, format or protocol identifiers (e.g. if the technology supports multiple protocol formats for the commands embedded in the multimedia content), etc.

FIGS. 8A to 8D are exemplary room lighting configurations viewed from different directions. By way of nomenclature, in these room layout illustrations, A indicates a centralized couch where one or more viewers might regularly sit to observe multimedia presentations in the room, B indicates a TV set (like 108 of FIG. 1), C indicates a luminaire in the form of a center channel LED strip (adjacent to one or more portions of the periphery of the TV type display device, e.g. framing the TV Set along several edges), D indicates a front-left channel luminaire, E indicates a front right channel luminaire, F indicates a rear left channel luminaire, G indicates a rear center channel luminaire, and H indicates a rear right channel luminaire. Where the lighting information track in the multimedia content supports the six control channels of FIG. 6B, commands from channels with LCIDs 1 to 6 would be reformatted and addressed in the appropriate lighting control protocol(s) and sent to via the data network 30 (FIG. 1) to the six luminaires C to H respectively. In addition to a luminaire adjacent to a portion of the periphery of the TV display B, the room views in these drawings show other luminaires located on a wall or a ceiling of a room in which the TV display device displays the images of the video data to a viewer on the couch A. For convenience only, the room views omit illustrations of the speaker(s) of the sound system.

FIG. 9 is a flow chart of a simple example of a procedure for receiving media of a multimedia production and providing an immersive lighting environment based on the received multimedia content. The media 500 may be obtained, for example, from a disk (e.g. a Blu-Ray disk) having embedded lighting related information embedded as part of the multimedia content. Similar procedures would be implemented for content obtained from other kinds of multimedia sources, such as in various other ways discussed above by which a media player 102 (FIG. 1) might obtain multimedia content and process and supply the content to the receiver/controller. In the example, the received multimedia content is supplied to the media receiver 50, 50a or 50b (see FIGS. 1-3), and most of the steps of the example of FIG. 9 from there on are implemented by the media receiver.

The example media reception and processing of FIG. 9 encompasses both the scenario in which the received multimedia content already includes an embedded lighting track and a scenario in which the received multimedia content does not yet include a lighting track. In the later scenario, a lighting track is procured as part of the processing of FIG. 9 for control of lighting during presentation of audio and video based on the received multimedia content.

At step 501, the media receiver detects input audio tracks (A) and a video track (V) and possibly lighting tracks (L) in the multimedia content obtained from the disk 104. In step 503, the media receiver determines whether or not lighting information is present in a lighting track in the received content. If not, processing branches from step 503 to 505. The immersive lighting functions could stop in the absence of lighting information in the obtained multimedia content. In the example, however, step 505 involves feeding the video track (V) and/or one or more of the audio tracks (A) to a processing routine to locally procure lighting control media content/commands (a more detailed example of which appears in FIG. 10).

In the process of FIG. 9, if lighting tracks (L) are present in the multimedia content obtained from the media 500, processing branches from step 503 to step 507. Alternatively, if a lighting track is procured in step 505, processing flows from 505 to step 507. In step 507, the media receiver 50, 50a or 50b (see FIGS. 1-3) decodes the information in the received or procured lighting track. In the example, the number of channels present in the lighting track and decoded in step 507 becomes a maximum number of lighting control channels for which the received lighting information explicitly provides control commands.

Depending on the number of luminaires 20 in a particular installation of a system 10 (FIG. 1), the number of lighting control channels may be expanded or reduced to match the equipment and capabilities of the particular system 10. Hence, in the example of FIG. 9, step 509 is a determination of the light sources available in the luminaires. Based on that determination, next step 511 determines the number and capabilities of usable control channels for the particular system, e.g. based on number of luminaires, locations of luminaires and/or configurations of the various luminaires.

At step 513, the media receiver coordinates the channels of received or procured lighting control information (decoded in step 507) into synchronized channels available in the particular system (as determined in step 511). The example shows several options, some or all of which may be supported by a particular implementation of the media receiver. Other synchronization strategies for step 513 may be included instead of or in addition to those shown.

In the example, one option involves interval synchronization of the number of color controllable channels available in the particular immersive lighting system. For each such system channel command RGB( . . . ), the luminaire(s) on a particular system control channel will implement the command when received and maintain the setting(s) specified by the command for a pre-set interval.

Another synchronization option shown relates to a timed synchronization in which a control command for each available channel is generated along with a dwell time (e.g. 4 s associated with the command RGB( . . . ) as shown in the drawing). For each such command in this second approach, the luminaire(s) on a particular system control channel will implement the command RGB( . . . ) when received for the associated time interval (4 s in the example).

A third synchronization option shown relates to an implement and “hold” synchronization technique. The media receiver generates and sends commands RGB( . . . ) over the available control channels at appropriate times, and the luminaire(s) on a particular system control channel will implement the command RGB( . . . ) when received and then hold the setting(s) of that command until another such command RGB( . . . ) is received for that particular system control channel.

The lighting commands for the various lighting control channels are synchronized with the audio and video data in step 515. The synchronized lighting commands for the various lighting control channels are converted to the appropriate lighting control device protocols, e.g. the particular wireless protocol used by the wireless transceivers in the system 10 of FIG. 1, as shown at step 517 in the flow chart of FIG. 5. Then, the commands are sent in as appropriately addressed wireless messages over the network to the respective luminaires. At step 519, each respective luminaire receives the respective lighting commands from the associated lighting control channel through the data network. In response, the luminaires control operations of the respective controllable light sources based on the respective lighting commands from the media receiver. Within the venue, the viewer 521 observing the presentation of audio and video by the multimedia presentation system 40 (FIG. 1) concurrently experiences the various lighting effects produced by the sources 130 in response to the commands received at the luminaires 20.

Although the example of FIG. 9 shows only a single protocol (see step 517), for convenience, the lighting controller capability of the media receiver may support more than one lighting control communication protocol, for example, adapted to support communications with different types of luminaires that communicate via different protocols. In a system with luminaires of one or more types that all utilize the same protocol, the lighting controller selects and implements the one lighting control communication protocol (from among the supported protocols) for the communication of the lighting commands to the luminaires of the immersive lighting system. In an installation, with two or more different types of luminaires using different communication protocols (e.g. from different lighting device manufacturers), step 517 may involve the lighting controller selecting and using the appropriate protocols from among the available the lighting control communication protocols supported by the receiver/lighting controller, where the selected protocols are suitable for the communication of the lighting commands to the different types of luminaires in the immersive lighting system.

FIG. 10 is a flow chart of a simple example of a procedure to procure lighting control information for a track of multimedia content, for embedding together with video and audio content tracks.

The process of FIG. 10 may be implemented for localized system 20 such as shown in FIG. 1 to obtain create a lighting track or to perform an analysis of the video and/or audio content to or create a lighting track at the venue. Alternatively, the process of FIG. 10 may be implemented in a remote manner by or coordinated through an on-line service or the like.

At a high level, once media is determined to not possess a matching lighting track on the online database, the media information is fed into the in-receiver lighting coordination algorithm. Within the algorithm, the media is decoded to obtain its video, audio, subtitle, genre, run time info and any other metadata embedded within the media. The video is analyzed separately for color, intensity dominances, overall color, intensity cues, including pixel averages (color majorities in certain pixel clusters), dramatic color changes, and color to contrast pairings. The audio and/or subtitles may be analyzed to pinpoint mood and tone shift, and the results of that analysis can paired with the video intensity (depending on the media in question), shifts within the overall plot and intended locations of audience focus.

These data points are combined, and used to create a maximum channel lighting track. That “full scale” lighting track is uploaded via the internet to the database where lighting tracks are store and curated. The locally created lighting track is then scaled to match the user specific environment (i.e., if maximum lighting capability of the track is 12 channels and the user has 5 channels, the full 12 channel track is scaled and optimized for the 5 channel user system environment). For a local track generation at a venue, for example, the optimized lighting track is returned to the output on the receiver and sent to the lighting hardware for consumption as described above relative to FIGS. 1 and 9.

With more specific reference to FIG. 10, in the example ‘Procure Media Content’ process flow, newly obtained multimedia content is received in step 701, with video and audio content tracks and possibly other tracks for closed captions or subtitles or alternate language audio, etc. (e.g. from step 500 to 503 in the process of FIG. 9). The multimedia content obtained in step 701 in the example procurement process of FIG. 10, however, does not yet include a lighting track. Lighting content may be obtained from another source, e.g. an on-line database, or created as a new track.

The Step 703 is a determination of whether the computer equipment currently handling the content is connected to the Internet. If yes, processing branches to step 705 where in the computer equipment checks an on-line lighting control information database to determine if a lighting control information data track is already available for the particular content obtained in 701. If so, processing branches to step 707 in which the available lighting control track is downloaded, and at step 709 processing returns to step 507 of FIG. 9 where the receiver decodes the downloaded track for lighting control coordinated with presentation of content from the other tracks of the received multimedia content 500.

In the media procurement process example of FIG. 10, if the determination in either step 703 (Internet connectivity) or step 705 (availability of a lighting control information data track) is negative, the processing flows to step 711. Step 711, for media analysis and decoder is a representation of processing to create a new lighting control information data track for the content obtained in step 701. Equipment and high level sub-steps that together implement step 711 are shown to the right of FIG. 10 and connected to the box 711 at beginning and ends by dotted line arrows.

Once creation of the lighting control information data track is completed in step 711, the process flows to step 709 where processing returns to step 507 of FIG. 9 and the receiver decodes the downloaded track for lighting control coordinated with presentation of content from the other tracks of the received multimedia content 500. Alternatively, for example, if the process of FIG. 10 is implemented by an on-line service, a new lighting track may be combined with the other tracks of the multimedia content from 500/701, in which case, the resulting combined multimedia content is now ready for distribution and use. Although not separately shown, that approach essentially makes that content with the lighting control track available for example for use as a content file download and processing as in the examples described above relative to FIGS. 1-4.

Returning to FIG. 10, the further processing to create a new lighting control data track may be implemented on a media player computer or system of computers (e.g. on a server and one or more user terminal computers) 721 running suitable media player software. Some functions of the media player 721 may be similar to those of the media players discussed above relative to FIGS. 1 to 3, for example, in terms of extracting and decoding audio and video tracks of the new multimedia content obtained in step 701. The media player functions at 721, however, may be extended, for example, to analyze the video and/or audio data to provide inputs to the next step of the creation procedure. The next step 723 implements a light coordination algorithm to create the lighting control information for a new data track based on the audio and video data from the tracks of the content obtained in step 701, in a manner that provides coordination of lighting and audio visual presentation in an immersive manner.

To complete the high level discussion of FIG, 10 before turning to a more detailed discussion of the light coordination algorithm, the media analysis and decoder operations of step 711 are completed by one or both of sub-steps 725, 727. The new lighting control data track may be combined with the tracks of the new multimedia content obtained in step 701 and the combined content made available for immersive lighting hardware in step 725. The new lighting track may also be added to the on-line database (step 727) for Internet access in steps 705, 707 of a subsequent run of the process of FIG. 10.

FIGS. 11A and 11B together form a flowchart of an example of a lighting coordination algorithm for use in the procedure of FIG. 10. The track creation and/or modification procedures of FIGS. 8 to 12 may be implemented on one or more computers, examples of which appear in FIGS. 13 and 14.

In the example process flow of FIGS. 11A and 11B, the media player (see 721 in FIG. 10) receives and begins processing the newly created multimedia content at step 801. At this point, the multimedia content typically includes video and audio content tracks and possibly one or more other track (e.g. for subtitles) but does not yet include embedded lighting control information. In step 803, the computer that is implementing the procedure breaks the content received in step 801 into raw RGB data and audio data. The computer may also obtain user input of diagnostic data (step 805) as well as outputs of a machine learning algorithm (step 807) as further inputs to the lighting coordination procedure.

Based on the inputs received in steps 803 to 807, the computer in step 809 splits the raw RGB data from the video, audio and other content by media type and begins the actual lighting coordination algorithm. The resulting split shown by way of example includes the video content data 811, audio content data 813 and subtitles content data 815. From additional data in the content or from user input (e.g. in step 805), the computer at 817 identifies the entertainment ‘genre’ of the multimedia content obtained at step 801. In the example, the computing device also obtains room information data 819 (such as a definition of a six channel lighting system for a typical venue).

In step 821, the computing device analyzes the raw RGB data of the video content with respect to events or scenes as might trigger or benefit from lighting effects on luminaires in the rooms indicated in the data 819. At 823, the computing device also implements an intensity monitor. Intensity here relates to the intensity of a scene or the like in a presentation of the multimedia content. The intensity monitor 823 acts as a method for selection of different scenes for association with lighting effects, in addition to selections based on the direct analysis of the video content at 821.

As shown in FIG. 11B by way of example, the analysis based on the video content data and the intensity monitor may use a pixel average of each whole video image (step 825). The computing device may also split images into sections for separate analysis (step 827). The computing device may also analyze frames in sequence to detect dramatic changes in color (step 829).

Lighting effects for association with identified images, scenes or segments of the video may be selected for an average over time (step 831) in relation to pixel average of video images (from 825) and/or based on aspects of split image sections (from 827). Some aspects the lighting effects may be hard coded, such as the number of quadrants (see step 833). Other aspects of some or all of the lighting effects may be based on light configuration (step 835), for example, as may be determined either by user setup or auto-configuration.

The flow chart also shows several ways in which the lighting control commands may be drafted/configured in relation to the audio/video content, for example to accentuate a change point for emphasis (step 837) based on a dramatic color change detected at 829. Depending on desired impact in the immersive presentation, the lighting commands may be drafted to control hue (step 839) of the lighting output(s) of the system (FIG. 1) or color contrast as paired to aspects of the video (step 841). Other aspects of lighting effects to be coordinated with the video and/or audio content may provide a color aspect of the lighting that is essentially the same (1 to 1 ratio) as particular images of the video (see step 843). Although not separately shown the effects determination portions of the lighting coordination algorithm, generally represented by steps 831 to 843 in the flow chart, will also determine timing of selected lighting effects, such as start and end times or start time and duration.

Based on the selected lighting effects and the timing relationship to images and scenes of the video (and thus with other synchronized content such the audio and subtitles), the computing device uses the room information from step 819 to generate individual commands for the lighting channels to implement the lighting effects as indicated by the steps of the coordination algorithm and compile those channelized lighting commands into a lighting track (see step 845).

The new lighting control data track from step 845 may be combined with the tracks of the multimedia content obtained in step 801 and the combined content sent to a receiver/lighting controller for immersive lighting hardware in step 847. The combined content may be communicated to the lighting controller in any of a variety of ways discussed above, for example, with regard to FIG. 1. The new lighting track from step 845 also may be sent via the Internet in step 849, e.g. for addition to the on-line database for Internet access in steps 705, 707 of a subsequent run of the process of FIG. 10.

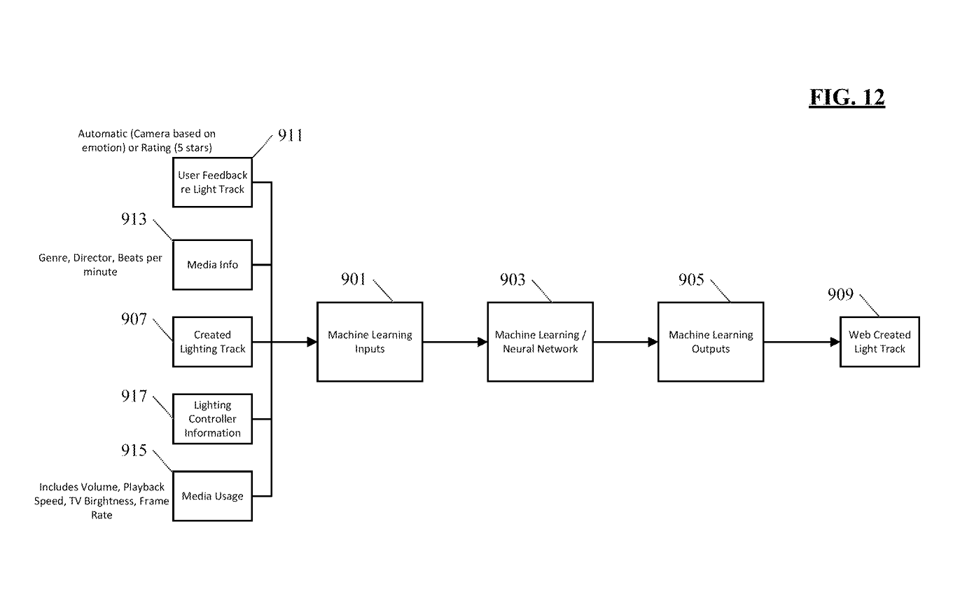

The newly created lighting track from step 845 also may be supplied (step 851) as an input to a machine learning procedure that modifies the track to obtain a new version based on various other inputs to the machine learning algorithm. FIG. 12 is a detailed example of a procedure to create a lighting track, for example, as a modified version of a lighting information data track created by the procedure of FIGS. 9, 10, 11A and 11B.

In the example of FIG. 12, the machine learning is implemented by steps 901 to 905. In step 901 a computer or system of computers implementing machine learning collects appropriate inputs. In step 903 the computing device applies a machine learning algorithm, such as a neural network, to the inputs; and in step 905, the algorithm causes the computing device to generate learned outputs.

In general, a machine learning algorithm such as the neural network used in step 903, “learns” how to manipulate various inputs, possibly including previously generated outputs, in order to generate current new outputs. As part of this learning process, the neural network or the like calculates weights to be associated with the various inputs. The weights are then utilized by the neural network to manipulate the inputs and generate the current outputs. Although FIG. 12 illustrates a simple example of the learning process, such a learning procedure may be more or less complex, including any number of inputs and outputs with a variable history (data set) that may be filtered or otherwise controlled and may implement any number of different learning algorithms.

In the example for a lighting control track, the computer or computing system collects a variety of inputs. One such input is a created lighting track 907. The track 907 may be a new track created by a procedure such as described above relative to FIGS. 9, 10, 11A and 11B. The track 907, however, may in some iterations of the process of FIG. 12 be a new track (or version of a track) created at 909 from the outputs 905 of the machine learning algorithm.

In the example, the inputs for machine learning also include user feedback 911, regarding the input light track 907. The feedback may be from one or more users of a particular venue input via a system 10 (FIG. 1), a collection of such feedback from users of multiple such venues/systems or feedback crowd sourced from various users via the Internet (e.g. via a social media site or the like). The feedback 911 may involve ratings (e.g. 1-5 stars) manually entered by users, for their overall impression of the track 907 or for their impressions of various portions of the track 907. Another approach might provide automatic feedback, for example based on analysis of images of users captured by a camera in the venue to determine emotional impact(s) on viewers by various lighting effects responsive to the track 907 performed during a multimedia content presentation.

Other inputs may include information 913 about the related program media content (e.g. about the audio/video program associated with the lighting track 907). This type of input information 913 may include genre of the program, the director of the program, beats per minute of the audio, and/or the like. The other inputs may include information 915 about the usage of the related program content during presentation to a user. This type of input information 915 may include audio volume, playback speed, display brightness, video frame rate of the displayed output, and/or the like.

Other inputs to the machine learning process may include various information 917 from the lighting controller. This type of input information 917 may include information about the number of channels, number and types of luminaires of the system utilized during the immersive lighting defined by the lighting track 907, that was the stimulus of the user feedback received at 911. If the lighting controller or other elements of the immersive lighting system include detectors, the information 917 may include other information about conditions in the particular venue at the time a user viewed the multimedia presentation with the lighting track 907 to which the feedback 911 relates. Such venue related sensed conditions might include occupancy information (e.g. number of occupants), information about any ambient lighting, temperature, and/or the like.

Still other inputs, such as artificial intelligent inputs, may be collected to direct content flow as part of the machine learning procedure for creating a new or modified lighting track.

The lighting track 907 and one or more of the other inputs 911 to 917 are supplied to the machine learning algorithm 903, which in the example, is a neural network algorithm. The computing device runs the neural network program to process these inputs and to generate new or modified lighting commands as current outputs at 905, which are compiled into a new version of the lighting track for association with the audio, video, subtitles, etc. of the program in the multimedia content. The new version or newly created track may be made available by an on-line service as a web created track 909, for example, for viewer/consumer selected use instead of a track created by the director who created a lighting track originally intended for use with the program content.

The discussion of examples of lighting track creation/modification above relative to FIGS. 5 and 9-12 mainly concentrated on creation and/or modification of a lighting track for association with the audio, video, etc. of relatively new multimedia content, such as a new multimedia file for a movie, television program or the like. The procedures also may be applied to create or modify a lighting track and associate such a track with content of other types. For example, similar procedures may be used to create or modify a lighting track and combine that track with tracks of audio, video, etc. content of pre-existing media, such as older movies, television programs, etc. Similar procedures also may be used to create or modify and combine that lighting track with a variety of other types of source media, such as books, audio books, music, games or the like.

Whether created by the machine learning process of FIG. 11, by a user implemented process similar to FIGS. 9, 11A and 11B or by some other user driven procedure (e.g. FIG. 5), new or modified lighting tracks may be accessible to users on-line. For example, a social media service or the like may collect new web created tracks in an on-line user driven database. Users could then download the tracks from the database for use during multimedia content presentations, either with content that did not have a lighting track when obtained by the users or for use instead of a director's original lighting track included with multimedia content. In this way, users who create such new or revised lighting tracks would be able to share their tracks with other users.

As shown by the above discussion, a variety of functions involved in immersive lighting may be performed via computer hardware platforms, such as the functions relating to creating and storing lighting tracks and other multimedia content and providing/collecting user or crowd sourced inputs and/or implementing the machine learning algorithm. Although special purpose devices may be used, such computer devices also may be implemented using one or more hardware platforms intended to represent general classes of data processing devices commonly used to run “server” programming and operate via an appropriate network connection for data communication and data processing devices used to run “client” or programming and operate as a user terminal via an appropriate network connection for data communication.

As known in the data processing and communications arts, a general-purpose computer typically comprises a central processor or other processing device, an internal communication bus, various types of memory or storage media (e.g. RAM, ROM, EEPROM, cache memory, disk drives etc.) for code and data storage, and one or more network interface cards or ports for communication purposes. The software functionalities involve programming, including executable code as well as associated stored data, e.g. files used for the creation and/or modification of lighting tracks or the storage and distribution of completed lighting tracks. The software code is executable by the general-purpose computer that functions as the server and/or that functions as a user terminal device. In operation, the code is stored within the general-purpose computer platform. At other times, however, the software may be stored at other locations and/or transported for loading into the appropriate general-purpose computer system. Execution of such code by a processor of the computer platform, for example, may enables the platform to implement the methodology for lighting track creation and/or the machine learning procedure, in essentially the manner performed in the examples of FIGS. 5 and 9 to 12.

FIGS. 13 and 14 provide functional block diagram illustrations of general purpose computer hardware platforms. FIG. 13 illustrates a network or host computer platform, as may typically be used to implement a server. FIG. 14 depicts a computer with user interface elements, as may be used to implement a personal computer or other type of work station or terminal device, although the computer of FIG. 14 may also act as a server if appropriately programmed. It is believed that those skilled in the art are familiar with the structure, programming and general operation of such computer equipment and as a result the drawings should be self-explanatory.

A server, for example (FIG. 13), includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature, and it is presumed that those skilled in the art are adequately familiar therewith. Of course, the server functions may be implemented in a distributed fashion on a number of similar platforms, to distribute the processing load.

A computer type user terminal device, such as a PC or tablet computer, similarly includes a data communication interface CPU, main memory and one or more mass storage devices for storing user data and the various executable programs (see FIG. 14). A mobile device type user terminal may include similar elements, but will typically use smaller components that also require less power, to facilitate implementation in a portable form factor. The various types of user terminal devices will also include various user input and output elements. A computer, for example, may include a keyboard and a cursor control/selection device such as a mouse, trackball, joystick or touchpad; and a display for visual outputs. A microphone and speaker enable audio input and output. Some smartphones include similar but smaller input and output elements. Tablets and other types of smartphones utilize touch sensitive display screens, instead of separate keyboard and cursor control elements. The hardware elements, operating systems and programming languages of such user terminal devices also are conventional in nature, and it is presumed that those skilled in the art are adequately familiar therewith.

It should be apparent from the discussion above that aspects of the methods of immersive lighting operations outlined above may be embodied in programming, e.g. in the form of software, firmware, or microcode executable by a luminaire, a media receiver/lighting controller or a media player and/or stored on a user computer system, a server computer or other programmable device for transfer to a luminaire, receiver or player. Program aspects of the technology may be thought of as “products” or “articles of manufacture” typically in the form of executable code and/or associated data that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the programming. All or portions of the programming may at times be communicated through the Internet or various other telecommunication networks. Such communications, for example, may enable loading of the programming from a computer or processor into a luminaire, a media receiver/lighting controller or a media player. Thus, another type of media that may bear the programming elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the programming.

Program instructions may comprise a software or firmware implementation encoded in any desired language. Programming instructions, when embodied in machine readable medium accessible to a processor of a computer system or other general purpose device, render computer system or general purpose device into a special-purpose machine that is customized to perform the operations specified in the program.

Other aspects of the methods of immersive lighting operations outlined above may be embodied in multimedia content wherein lighting information is embedded in the content together with related video and audio content. Such aspects of the technology may be thought of as “products” or “articles of manufacture” typically in the form of any of the above-discussed machine readable media, multimedia content on the particular medium, where the multimedia content has lighting information data tracks of channels of lighting commands embed together with tracks of audio data and a track of video data.

As used herein, unless restricted to one or more of “non-transitory,” “tangible” or “storage” media, terms such as computer or machine “readable medium” refer to any medium that participates in providing instructions to a processor for execution or provides suitable multimedia content to a receiver or player.

Hence, a machine readable medium may take many forms, including but not limited to, a tangible storage medium, a carrier wave medium or physical transmission medium. Non-volatile storage media include, for example, optical or magnetic disks, such as any of the storage devices in any examples of a media player, a media receiver/lighting controller, luminaires, or computer(s) or the like shown in the drawings. Volatile storage media include dynamic memory, such as main memory of any such hardware platform. Tangible transmission media include coaxial cables; copper wire and fiber optics, including the wires that include a bus within a computer, luminaire, media player or media receiver. Carrier-wave transmission media can take the form of electric or electromagnetic signals, or acoustic or light waves such as those generated during radio frequency (RF) and light-based data communications. Common forms of computer-readable media therefore include for example: a floppy disk, a flexible disk, hard disk, magnetic tape, any other magnetic medium, a compact disk read only memory (CD-ROM), a digital video disk (DVD), a digital video disk read only memory (DVD-ROM), a high definition DVD, or an ultra-high definition DVD, any other optical medium, punch cards paper tape, any other physical storage medium with patterns of holes, a RAM, a PROM and EPROM, a FLASH-EPROM, any other memory chip or cartridge, a carrier wave transporting content data or instructions, cables or links transporting such as a carrier wave, or any other medium from which a machine can read programming code and/or content data. Many of these forms of machine readable media may be involved in carrying multimedia content and/or one or more sequences of one or more instructions to a processor.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as ±10% from the stated amount.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

1. An immersive lighting system, comprising:
a data network;
luminaires, each respective one of the luminaires comprising:
a controllable light source positioned to output light in a space where a multimedia system displays video and outputs audio;
a network interface to enable the respective luminaire to receive communications via the data network; and
a central processing unit, coupled to the light source of the respective luminaire and to the network interface of the respective luminaire, configured to control operation of the light source of the respective luminaire based on respective lighting commands received via the network interface of the respective luminaire; and
a receiver, comprising:
a multimedia interface to obtain multimedia content, the multimedia content comprising video data and audio data intended to also be received by the multimedia system, wherein the multimedia content further comprises embedded lighting information;
a network interface to enable the receiver to communicate with the luminaires over the data network; and
a processor coupled to the network interface and to the multimedia interface, the processor being configured to:
generate the respective lighting commands for each respective one of the luminaires based on the embedded lighting information from the multimedia content; and
cause the network interface of the receiver to send respective lighting commands via the data network to each respective one of the luminaires,
wherein each respective luminaire is configured to receive the respective lighting commands via the respective data network and to control operation of the respective controllable light source of the respective luminaire based on the respective lighting commands received from the receiver.

2. The immersive lighting system of claim 1, wherein:
the multimedia system includes a display device configured to receive and display image data based on the video data from the multimedia content, and
at least one of the luminaires is arranged along a portion of a periphery of the display device.

3. The immersive lighting system of claim 2, wherein another of the luminaires is located on a wall or a ceiling of a room in which the display device displays the image data.

4. The immersive lighting system of claim 1, wherein the controllable light source in each respective one of the plurality of luminaires is a non-display type light source configured for controllable artificial general illumination.

5. The immersive lighting system of claim 4, wherein the controllable light source in each respective one of the plurality of luminaires is at least one of a point light source or a light bar type light source.

6. An immersive lighting system, comprising:
a data network;
luminaires, each respective one of the luminaires comprising:
a controllable light source positioned to output light in a space where a multimedia system displays video and outputs audio;
a network interface to enable the respective luminaire to receive communications via the data network; and
a central processing unit, coupled to the light source of the respective luminaire and to the network interface of the respective luminaire, configured to control operation of the light source of the respective luminaire based on respective lighting commands received via the network interface of the respective luminaire;
a receiver, comprising:
a multimedia interface to obtain multimedia content, the multimedia content comprising video data and audio data intended to also be received by the multimedia system, wherein the multimedia content further comprises embedded lighting information;
a network interface to enable the receiver to communicate with the luminaires over the data network; and
a processor coupled to the network interface and to the multimedia interface, the processor being configured to:
generate the respective lighting commands for each respective one of the luminaires based on the embedded lighting information from the multimedia content and
cause the network interface of the receiver to send respective lighting commands via the data network to each respective one of the luminaires,
wherein each respective luminaire is configured to receive the respective lighting commands via the respective data network and to control operation of the respective controllable light source of the respective luminaire based on the respective lighting commands received from the receiver; and
a media player configured to obtain the multimedia content including the video data, the audio data and the embedded lighting information from a multimedia source, and supply the multimedia content obtained from the multimedia source to the multimedia interface of the receiver as a data stream.

7. The immersive lighting system of claim 6, wherein the lighting information is embedded as data in predetermined lighting tracks within the multimedia content obtained from the multimedia source and in lighting tracks in the data stream supplied from the media player to the multimedia interface of the receiver.

8. The immersive lighting system of claim 7, wherein the processor is further configured to generate respective lighting commands for each of the luminaires based on the embedded lighting information from one or more of the lighting tracks of the data stream supplied from the media player.

9. The immersive lighting system of claim 8, wherein the media player is configured to obtain the multimedia content as a digital program content file downloaded or streamed in real-time via a communication interface of the media player.

10. The immersive lighting system of claim 6, wherein the media player is configured to:
obtain the multimedia content from a non-transitory computer readable medium having the encoded lighting information in lighting tracks stored thereon together with tracks of the video data and the audio data; and
include the lighting information in lighting tracks in the data stream supplied from the media player to the multimedia interface of the receiver.

11. The immersive lighting system of claim 10, wherein the processor is further configured to generate respective lighting commands for each of the luminaires based on the embedded lighting information from one or more of the lighting tracks of the data stream supplied from the media player.

12. The immersive lighting system of claim 10, wherein the non-transitory computer readable medium is a compact disk read only memory (CD-ROM), a digital video disk (DVD), a digital video disk read only memory (DVD-ROM), a high definition DVD, or an ultra-high definition DVD.

13. The immersive lighting system of claim 1, wherein:
the processor and the network interface of the receiver together operate as a lighting controller relative to the luminaires;
the lighting controller supports a plurality of lighting control communication protocols adapted to communicate with different types of luminaires; and
the lighting controller implements at least a selected one of the lighting control communication protocols for the communication of the lighting commands to the luminaires of the immersive lighting system.

14. The immersive lighting system of claim 1, wherein:
the network interface of the receiver comprises a wireless transceiver;
each of the network interfaces of the luminaires comprises a wireless transceiver compatible with over-the-air communications with the wireless transceiver of the receiver;
the data network is a wireless network formed by the wireless transceivers of the receiver and the luminaires; and
the respective lighting commands are provided to respective luminaires via wireless communications.

15-23. (canceled)

24. An immersive lighting system, comprising:
a data network;
luminaires, each respective one of the luminaires comprising:
a controllable light source positioned to output light in a space where a multimedia system displays video and outputs audio;
a network interface to enable the respective luminaire to receive communications via the data network; and
a central processing unit, coupled to the light source of the respective luminaire and to the network interface of the respective luminaire, configured to control operation of the light source of the respective luminaire based on respective lighting commands received via the network interface of the respective luminaire; and
a receiver, comprising:
a multimedia interface to obtain multimedia content, the multimedia content comprising video data and audio data intended to also be received by the multimedia system, wherein the multimedia content further comprises embedded lighting information;
a network interface to enable the receiver to communicate with the luminaires over the data network; and
a processor coupled to the network interface and to the multimedia interface, the processor being configured to:
generate the respective lighting commands for each respective one of the luminaires based on the embedded lighting information from the multimedia content; and
cause the network interface of the receiver to send respective lighting commands via the data network to each respective one of the luminaires, wherein:
each respective luminaire is configured to receive the respective lighting commands via the respective data network and to control operation of the respective controllable light source of the respective luminaire based on the respective lighting commands received from the receiver,
the lighting information is embedded as data in predetermined lighting tracks within the multimedia content in a data stream obtained from a multimedia source, and
the processor is further configured to generate respective the lighting commands for each of the luminaires based on the embedded lighting information from one or more of the lighting tracks.

25. The immersive lighting system of claim 24, wherein:
the processor and the network interface of the receiver together operate as a lighting controller relative to the luminaires;
the lighting controller supports a plurality of lighting control communication protocols adapted to communicate with different types of luminaires; and
the lighting controller implements at least a selected one of the lighting control communication protocols for the communication of the lighting commands to the luminaires of the immersive lighting system.

26. The immersive lighting system of claim 24, wherein:
the network interface of the receiver comprises a wireless transceiver;
each of the network interfaces of the luminaires comprises a wireless transceiver compatible with over-the-air communications with the wireless transceiver of the receiver;
the data network is a wireless network formed by the wireless transceivers of the receiver and the luminaires; and
the respective lighting commands are provided to respective luminaires via wireless communications.
